(19) United States
(12) Patent Application Publication
(10) Pub. No.: US 2015/0371283 A1
(43) Pub. Date: Dec. 24, 2015

(54) SYSTEM AND METHOD FOR MANAGING OR DISTRIBUTING PROMOTIONAL OFFERS

(71) Applicant: The Sampler App Inc., Toronto (CA)

(72) Inventors: Marie-Pier CHEVRIER, Toronto (CA); Christian DITTMAR, Berlin (DE)

(21) Appl. No.: 14/749,144

(22) Filed: Jun. 24, 2015

Related U.S. Application Data
(60) Provisional application No. 62/016,461, filed on Jun. 24, 2014.

(51) Int. Cl. G06Q 30/02

(52) U.S. Cl. CPC G06Q 30/0269

(57) ABSTRACT

A system is provided for managing or distributing promotional offers to one or more users, each with one or more characteristics, comprising: one or more utilities configured to track the distribution of one or more promotional offers to one or more eligible users; one or more utilities configured for defining one or more sets of rules; one or more utilities configured for applying one or more sets of rules; wherein the one or more sets of rules define various properties of the one or more promotional offers; and wherein the one or more eligible users are a subset of the one or more users.

### CROSS-REFERENCE TO RELATED APPLICATIONS

This application claims all benefit, including priority, of U.S. provisional patent application Ser. No. 62/016,461, filed 24 Jun. 2014 and entitled “SYSTEM AND METHOD FOR MANAGING OR DISTRIBUTING PROMOTIONAL OFFERS” the entire contents of which are herein incorporated by this reference.

### FIELD

The present disclosure relates generally to promotional campaigns, and more particularly to systems and methods for managing or distributing promotional offers.

### BACKGROUND

The conducting of promotional campaigns can be an expensive and arduous process for various organizations. Promotional campaigns may often involve the distribution of promotional offers, such as product samples, coupons, exclusive access, and/or other various offers.

One of the challenges facing the distribution of promotional offers is the ability to manage the distribution of promotional offers in a way that is both effective and cost efficient. It may be difficult to manage the distribution of promotional offers as it is often difficult to track whether the promotional offers have been redeemed, who has actually redeemed the offers, whether the offers have been communicated to others, etc. It can also be difficult and/or cumbersome to track the distribution of promotional offers against existing inventories of promotional offers and/or conduct various analytics based on the information generated from the promotional offer.

Further, it may be a challenge to restrict the group of people receiving promotional offers to only a desirable demographic. As such, many promotional offers may be provided to individuals who may be outside of the target demographic for a product.

### SUMMARY

A computer implemented method for managing distribution of one or more promotional offers to one or more users, performed by a processor of a distribution management system, the method comprising: storing user specific information in the form of electronic user profiles, each user profile corresponding to each of the one or more users; periodically monitoring inventory levels of one or more promotional offers; establishing a first set of eligibility parameters, the eligibility parameters being based at least on the user specific information stored in the electronic user profiles and defining a subset of the one or more users; upon receipt of a signal indicative of a user's interest in receiving one of more promotional offers, automatically determining eligibility of the user to receive the one or more promotional offers based in part on characteristics stored within the electronic user profile corresponding to the user and the inventory levels of the one or more promotional offers; where the user is determined to be eligible to receive the one or more promotional offers, distributing a first set of promotional offers to the user; where the user is determined not to be eligible to receive the one or more promotional offers, distributing a second set of promotional offers to the user; wherein the first set of promotional offers is different than the second set of promotional offers; updating the inventory levels based on the set of promotional offers distributed to the user; determining whether the inventory levels of the one or more promotional offers will be reduced below a predefined threshold; and upon a determination that the inventory levels will be reduced below a predefined threshold, establishing a second set of eligibility parameters defining a subset of the one or more users that is smaller than the subset defined by the first set of eligibility parameters.

In another aspect, the user specific information stored in the form of the electronic user profiles includes an electronic listing of one or more other users connected with the user associated with each electronic user profile, and user characteristic information for each of the one or more other users.

In another aspect, the step of distributing the first set of promotional offers to the user further comprises: retrieving the electronic listing of the one or more other users connected with the user; using the first set of eligibility parameters, determining an eligible subset of the one or more other users; presenting, through a user interface coupled to the distribution management system, the eligible subset of the one or more other users to the user; receiving, through the user interface coupled to the distribution management system, a selection of one or more other users by the user; and transmitting an electronic invitation to receive the first set of promotional offers to the selected one or more other users.

In another aspect, the method further comprising providing an invitation to the one or more users in the form of an electronic resource locator, including at least one of a uniform resource locator (URL) and a quick reaction code (QR code).

In another aspect, the invitation is provided through at least one of an in-store advertisement, an insert provided in a product, on product packaging, a print publication, and an electronic advertisement.

In another aspect, the first set of eligibility parameters or the second set of eligibility parameters include at least a parameter related to whether a user has an association with an electronic profile of an organization affiliated with the one or more promotional offers.

In another aspect, the method further comprises determining one or more economic scores for each of the one or more users based at least in part on user specific information stored in the users' electronic user profiles; wherein at least one of the first and second sets of eligibility criteria include a criterion related to the determined economic scores.

In another aspect, the one or more potential economic scores includes at least one of a future revenue score, and a future profit score.

In another aspect, the inventory levels are indicative of current and expected inventory availability.

In another aspect, the one or more users provides the signal indicative of the user's interest in receiving the one or more promotional offers through at least one of a signal generated through the use of a social media platform, a mobile application, and a computer program.

In another aspect, the one or more promotional offers includes at least one online coupons, physical coupons, physical products, virtual products, services, options to purchase, options to sell, exclusive access, reservations, rebates, contests, premium offers, and access to special sales events.

In another aspect, the method further comprising upon receipt of the signal indicative of a user's interest in receiving one of more promotional offers, updating the electronic user profile associated with the user to include user specific information relating to the source of the signal indicative of the user's interest.

In another aspect, the method further comprising upon receipt of the signal indicative of a user's interest in receiving one of more promotional offers, inferring demographic characteristics of the user relating to the source of the signal indicative of the user's interest and updating the electronic user profile associated with the user to include the inferred demographic characteristics of the user.

In another aspect, a system is provided for managing distribution of one or more promotional offers to one or more users, the system having a processor and non-transitory computer readable media, the non-transitory computer readable media containing electronic instructions which cause the processor to: store user specific information in the form of electronic user profiles, each user profile corresponding to each of the one or more users; periodically monitor inventory levels of one or more promotional offers; establish a first set of eligibility parameters, the eligibility parameters being based at least on the user specific information stored in the electronic user profiles and defining a subset of the one or more users; upon receipt of a signal indicative of a user's interest in receiving one of more promotional offers, automatically determine eligibility of the user to receive the one or more promotional offers based in part on characteristics stored within the electronic user profile corresponding to the user and the inventory levels of the one or more promotional offers; where the user is determined to be eligible to receive the one or more promotional offers, distribute a first set of promotional offers to the user; where the user is determined not to be eligible to receive the one or more promotional offers, distribute a second set of promotional offers to the user; wherein the first set of promotional offers is different than the second set of promotional offers; update the inventory levels based on the set of promotional offers distributed to the user; determine whether the inventory levels of the one or more promotional offers will be reduced below a predefined threshold; and upon a determination that the inventory levels will be reduced below a predefined threshold, establish a second set of eligibility parameters defining a subset of the one or more users that is smaller than the subset defined by the first set of eligibility parameters.

In another aspect, a computer implemented method is provided for managing distribution of one or more promotional offers to one or more users, performed by a processor of a distribution management system, the method comprising: storing user specific information in the form of electronic user profiles, each electronic user profile corresponding to each of the one or more users; periodically monitoring inventory levels of one or more promotional offers; establishing a set of eligibility parameters, the eligibility parameters being based at least on the user specific information stored in the electronic user profiles and defining a subset of the one or more users; upon receipt of a signal indicative of a user's interest in receiving one of more promotional offers, automatically determining eligibility of the user to receive the one or more promotional offers based in part on characteristics stored within the electronic user profile corresponding to the user and the inventory levels of the one or more promotional offers; where the user is determined to be eligible to receive the one or more promotional offers, distributing the set of promotional offers to the user.

In another aspect, a computer implemented method is provided for managing distribution of one or more promotional offers to one or more users, performed by a processor of a distribution management system, the method comprising: storing user specific information in the form of electronic user profiles, each electronic user profile corresponding to each of the one or more users; periodically monitoring inventory levels of one or more promotional offers; establishing a set of eligibility parameters, the eligibility parameters being based at least on the user specific information stored in the electronic user profiles and defining a subset of the one or more users; upon receipt of a signal indicative of a user's interest in receiving one of more promotional offers, automatically determining eligibility of the user to receive the one or more promotional offers based in part on characteristics stored within the electronic user profile corresponding to the user and the inventory levels of the one or more promotional offers; where the user is determined not to be eligible to receive the one or more promotional offers, notifying the user that the user is not eligible to receive the one or more promotional offers.

In another aspect, a method for managing distribution of one or more promotional offers to one or more users is provided, performed by a processor of a distribution management system, the method comprising: storing user specific information in the form of electronic user profiles, each electronic user profile corresponding to each of the one or more users; periodically monitoring inventory levels of one or more promotional offers; establishing a set of eligibility parameters, the eligibility parameters being based at least on the user specific information stored in the electronic user profiles and defining a subset of the one or more users; upon receipt of a signal indicative of a user's interest in receiving one of more promotional offers, automatically determining eligibility of the user to receive the one or more promotional offers based in part on characteristics stored within the electronic user profile corresponding to the user and the inventory levels of the one or more promotional offers; where the user is determined to be eligible to receive the one or more promotional offers, distributing the set of promotional offers to the user; receiving an redemption request from the user associated with one or more promotional offers from the set of promotional offers; determining inventory levels of the one or more promotional offers that have been indicated as redeemed by the user; upon determining that inventory levels for a promotional offer has been depleted, flagging the promotional offer as depleted and deactivating the promotional offer.

In another aspect, a non-transitory computer readable medium is provided storing instructions thereon which when executed, cause a processor to perform steps of a method comprising: storing user specific information in the form of electronic user profiles, each electronic user profile corresponding to each of the one or more users; periodically monitoring inventory levels of one or more promotional offers; establishing a set of eligibility parameters, the eligibility parameters being based at least on the user specific information stored in the electronic user profiles and defining a subset of the one or more users; upon receipt of a signal indicative of a user's interest in receiving one of more promotional offers, automatically determining eligibility of the user to receive the one or more promotional offers based in part on characteristics stored within the electronic user profile corresponding to the user and the inventory levels of the one or more promotional offers; where the user is determined not to be eligible to receive the one or more promotional offers, notifying the user that the user is not eligible to receive the one or more promotional offers.

In another aspect, the system is comprised of: one or more utilities configured to track the distribution of one or more promotional offers to one or more eligible users; one or more utilities configured for defining one or more sets of rules; one or more utilities configured for applying one or more sets of rules; wherein the one or more sets of rules define various properties of the one or more promotional offers; and wherein the one or more eligible users are a subset of the one or more users.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments of the present disclosure are illustrated by way of example. It is to be expressly understood that the description and drawings are only for the purpose of illustration and as an aid to understanding, and are not intended as a definition of the limits of the present disclosure.

Embodiments will now be described, by way of example only, with reference to the attached figures, wherein:

FIG. 1 is an illustrative diagram providing generic computer hardware and software for implementation of certain aspects, as detailed in the description.

FIG. 2 provides a high-level block schematic of a campaign/promotional offer management and/or distribution system, according to some embodiments.

FIG. 3A provides a workflow diagram of a process to distribute promotional offers, according to some embodiments.

FIG. 3B provides a workflow diagram of a process to dynamically establish eligibility criteria, according to some embodiments.

FIG. 4 provides a sample screenshot of a page where a potential user is not allowed to send a recommendation or to claim a sample, according to some embodiments.

FIG. 5 provides a sample screenshot of an interface where only friends that matched a set of demographic criteria are shown, according to some embodiments.

FIG. 6 provides a sample screenshot of an interface where a “story” is designated to be posted to a user's Facebook™ wall, according to some embodiments.

FIG. 7 provides a sample screenshot of an interface where a user is displayed a message where all the promotional offers have already been sent, according to some embodiments.

FIG. 8 provides a sample screenshot of an interface where a user is displayed a screen indicating that one sample (the Full Packette Trio) has been had its inventory exhausted, according to some embodiments.

FIG. 9 provides a sample screenshot of an interface where a user is displayed a screen where the user may select a delivery method, also an option to sign up for promotional emails and send a private message, according to some embodiments.

FIGS. 10 and 11 provide sample screenshots of the administrative interface that may be configured to enable an administrator to determine the look and feel the user interface, according to some embodiments.

FIG. 12 provides a sample screenshot of the administrative interface that may be configured to define various characteristics and/or rules related to one or more promotional offers, according to some embodiments.

FIGS. 13A and 13B provide sample screenshots of the administrative interface that may be configured to provide an administrator with a view of tracked statistics, according to some embodiments.

FIGS. 14A and 14B provides sample screenshots of the administrative interface that may be configured to provide an administrator the ability to set eligibility criteria and options related to a promotional offer, according to some embodiments.

FIG. 15 provides sample screenshots of a user interface illustrating product recommendations of other promotional offers, according to some embodiments.

FIG. 16 provides a sample screenshot of the administrative interface that may be configured to provide an administrator with a view of inventory and redemption statistics, according to some embodiments.

FIG. 17 provides a sample screenshot of a sample advertisement on a social networking platform containing an embedded uniform resource locator, according to some embodiments.

FIG. 18 provides a sample screenshot of the sample advertisement on a website containing an embedded uniform resource locator, according to some embodiments.

FIG. 19 provides a sample screenshot of product packaging containing an embedded quick response code, according to some embodiments.

FIG. 20 provides a sample screenshot of a magazine page containing an embedded quick response code, according to some embodiments.

FIG. 21 provides sample screenshots an in-store advertisement containing an embedded quick response code, according to some embodiments.

### DETAILED DESCRIPTION

Preferred embodiments of methods, systems, and apparatus suitable for use in implementing the present disclosure are described through reference to the drawings.

The present disclosure, in one aspect, provides systems and methods for online promotional campaigns.

Traditional methods of distributing promotional offers may include handing out coupons, flyers, etc., or the mailing of the same. However, it is often difficult to send out promotional offers based on a set of rules, and is difficult to dynamically modify the promotional offers as various conditions are triggered. Further, a challenge with traditional methods of distributing promotional offers is the ability to dynamically respond and/or modify campaign rules as various factors change and/or evolve. For example, the number of promotional offers available may reduce, the campaign may not be attracting the right audiences, etc., and the ability to actively monitor and/or respond may be useful.

A quick response may be particularly useful, especially in the age of digital marketing and/or communications, to indicate to potential users/consumers that, for example, a product has run out prior to ordering, instead of disappointing users by having them sign up and then informing them that there are actually no products left.

In the context of electronic/computerized implementation, there are several technologies that provide tools that may be beneficial to the marketing of promotional offers. For example, physical inventory tracking systems may be available and provide interfaces in which real-time inventory levels, demand, and supply can be independently tracked (e.g., the exact number of samples left, where the samples are), verified (e.g., determining that an offer was redeemed at a particular distribution location having a specific tracking code), and managed (e.g., re-ordering supplies, shifting supplies from one location to another).

Various enterprises promote and sell a wide range of products and/or services. Promotion and sales involve various sales activities, including various interactions between sales personnel and channel partners such as distributors or retailers.

Across the world, social networks are becoming an increasingly popular medium for staying in touch with friends. Social networks are also becoming an effective tool for business learning, sales and networking. As a result of this popularity, certain social networks such as Facebook™ and LinkedIn™ have millions and millions of users.

Some embodiments are specifically designed and implemented to utilize the ability of and information stored on social networks to advantageously target and/or filter potential recipients such that eligibility for various programs may be determined in a highly specific and highly sensitive manner. A potential advantage of using such information for targeting and/or eligibility determinations is that the information is fairly updated, self-reported, and widely available, including information that may be retrieved from the various connections and associations that have been established between various users. Social networks also include the ability for users to create content (e.g., posting on a board/wall), send private messages, establish relationships with organizations (e.g., creating/liking fan pages, engaging corporate pages), etc.

Accordingly, social networks are a technology that was developed after widespread use of the internet and provide new and unique opportunities for the dissemination of promotion offers and/or products, and some embodiments of the present disclosure may not have been possible without the Internet and/or computerized implementation.

Social networks may be advantageously leveraged to develop solutions for the distribution and/or management of promotional offers, for example, increasing the specificity and/or sensitivity of distributing targeted promotional offerings into a specific demographic. There may be the use of logical rules, etc., that leverage information stored on and/or derived from social networks.

In some embodiments, the system may be configured to provide various features, such as, but not limited to the provisioning of one or more promotional offers; the creation, distribution, application and/or tracking of coupons; the ability for brand managers to view various analytics; the ability for the system to provide decision support; the ability for the system to dynamically provide decision support responsive to various changes and/or the management of one or more online promotional campaigns wherein one or more promotional offers are distributed. The decision support functionality may be provided based on narrow objectives, or in some embodiments, decision support functionality may aid in the identification and/or discovery of campaign objectives and/or leading practices.

Administrators and/or brand administrators may utilize the system to manage the distribution of one or more promotional offers. In some embodiments, users may be able not only to redeem promotional offers, but also to invite a subset of their contacts to receive promotional offers.

The system may include one or more utilities that manage the definition, application and/or monitoring of one or more rules. The one or more rules may provide a flexible implementation whereby the one or more rules can be defined to be triggered upon various occurrences, and may lead to one or more actions being taken. For example, rules may be defined to monitor for various variables and to change various aspects of the distribution of the promotional offers accordingly. Similarly, rules may be applied to define and/or dynamically maintain exclusivity and act as a gatekeeper for various functionality accessible to users. For example, rules may be defined so that only a subset of a user's contacts may be eligible for a particular promotional offer.

In some embodiments, the rules may be defined to prioritize the contacts of a particular user and/or provide the contacts in a prioritized list.

The system may also provide various monitoring, statistical and/or analytical capabilities, which may aid brand administrators and/or administrators in keeping track of the performance of various campaigns.

In various embodiments, the system provides a platform for decision support, where administrators and/or brand administrators may be able to receive various suggestions from the system as determined by a set of rules, and these suggestions may vary depending on the objectives, target audience, product/service type, etc. of the promotional offers in one or more campaigns. The decision support may, in some embodiments, provide feedback in relation with industry averages and/or any other type of available metrics.

### Operating Environment

In some embodiments, one or more users, one or more brand administrators and/or one or more administrators utilize the system for various functions related to online promotional campaigns.

The one or more users may be various individuals, and may have one or more characteristics associated with them. In some embodiments, the one or more characteristics may include any information regarding the users, and may further include information derived from various external databases and external systems.

The users may be customers, potential customers, an advocate of a product, someone who has indicated that the user ‘liked’ a page, etc.

For example, the one or more characteristics may include personal/physical characteristics, such as height, weight, gender, body type, hair color, skin color, hair type, skin type, hair length, eye color, shoe size, whether the user has children, the number of children, the gender of children, etc.

The one or more characteristics may also include demographic and/or socioeconomic characteristics, such as level of education, individual income, household income, schools attended, occupation of the user, etc.

The one or more characteristics may also include user behavior such as past consumption trends, predicted future consumption trends, past purchases, recent purchase history, presence of a small/large interest in particular products/types of products, etc.

The one or more characteristics may also include social media behavior, such as number of Facebook™ friends, number of LinkedIn™ contacts, number of Twitter™ followers, number of tweets, number of posts, whether the user has posted information from the system in the past, whether the user has integrated his/her account with external social media systems, their perceived influence on systems such as Klout™, etc.

The one or more characteristics may also include system related variables, such as how the user found the system, whether the user was referred to the system, who the user was referred by to the system, whether the user has received samples before, whether the user has receives samples from a related product before, how long the user has been using the system, how frequently the user has been using the system, how active the user is in using the system, etc.

The one or more characteristics may also include characteristics received from one or more external systems, such as a consumer relationship management (CRM) database, brand management databases, various user information databases, mailing lists, subscription lists, etc.

The one or more characteristics may also be derived from questionnaires, statistical analysis, etc. For example, the system may be configured to ask the user some questions when the user enters a webpage, is seeking to redeem an offer, seeking to refer a friend, etc.

In some embodiments, this information may be used to determine what type of promotional offer best fits the demographics for the individual (or answered questions). For example, rather than having a individual determine which promotion is of interest to the individual and actively seeking out a specific promotion, the individual may request that the system find one or more relevant promotions that is system may determine an interest for the individual and the individual may be eligible for.

The one or more administrators may include individuals who may be managing branding campaigns. The one or more administrators may include individuals and/or third parties who may be engaged to help one or more branded companies manage campaigns.

The one or more brand administrators may include individuals such as brand managers who may be managing branding campaigns and/or setting up one or more branding campaigns. These brand administrators may include, for example, a marketing manager engaged within a branded organization in charge of distributing promotional offers, etc.

In some embodiments, the one or more brand administrators may also pay to use the system. Various payment models may be considered, for example, a pay-per-promotional offer, a volume model, fees charged per feature (e.g. customizations), a flat fee, and/or combinations of various payment models. The brand administrators may be able to pay for the services through various means, such as purchasing credit, a prepaid model, a post-paid model, a subscription model, etc. The purchased credit, in some embodiments, may be referred to as “campaign credit” (e.g., a virtual currency).

The system may be implemented in various ways, such as in a distributed networking solution, such as a cloud network, or on one or more physical servers with one or more processors, one or more non-transitory computer readable media, etc.

In some embodiments, the system may be implemented using a software-as-a-service model, and may be accessible through, for example, a web interface.

In some embodiments, the system may be implemented through, or in conjunction with, one or more social media platforms. Such implementation may be seamless, and may utilize various functionality available through the social media platforms, such as native objects, function calls, information queries, etc., and may also include other conventional social networking functions.

In this disclosure, by “social networking platform”, any computer network implemented application platform is meant that is operable to generate a series of web pages so as to define a series of user interactions and/or workflows, including social media interactions, that define a social networking environment described herein.

“Friends/contacts” may refer to two or more users of a social networking platform who share one or more social interaction privileges by operation of the social networking platform, based on one or more pre-established rules. Conferring the social interaction privileges may require user acceptance and/or may be assigned automatically by the social networking platform based on the rules. “Fans” may refer to one or more users who may indicate that they are associated with and/or like one or more branded companies, products, services, etc.

“Social media interactions” may refer to the various interactions between users of a social networking platform (including “friends”), including various communications (such as platform messaging, instant messaging, videoconferencing, voice messaging, etc.), uploading or posting content in one or more media, downloading content in one or more media, watching content in one or more media, reviewing or rating content including “objects”, taking a quiz, selling or trading items such as “objects”, and so on. “Objects” may include any content or media object that may be used or consumed in connection with social interactions, such as for example a social feed, a message, a use case, a video, a quiz, a survey, a questionnaire, a tip, a discussion, a digital good, etc.

In some embodiments, the system may be accessed through other platforms, social networking platforms, and/or may utilize various programmatic interfaces, such as application programmable interfaces (APIs). For example, the system may be integrated with Facebook™, and/or other systems, and in some embodiments, may also be configured to integrate with various features within these interfaces as well, such as Facebook™ Fan Pages. The system may integrate accordingly with other external interfaces as well.

In some embodiments, the system may be configured to interact with various external systems, communicating information and/or providing command and control capabilities to/from the various external systems. For example, the system may be configured to interact with the brand management tool for a particular vendor. In such an example, the system may provide analytics and/or control capabilities to the brand management tool, and such communications may be governed by a protocol such as an application programmable interface (API).

In some embodiments, the system may be configured to interact with various inventory systems, for interacting with inventory that may be distributed and/or provisioned by the system. Inventory may be virtual and/or physical, and may range from objects such as product samples to online coupon codes. The inventories may take into account, for example, offers that have been distributed but not yet redeemed, etc.

In some embodiments, the system may also be configured to interact with various order shipping and/or fulfillment systems. For example, if the system collects a user's address and shipping information, the system may be configured to coordinate the shipping of the product from a warehouse automatically.

A potential advantage of integration with various social networks and/or external systems may be the ability to provide a unified user interface experience that is familiar to the users, and enables interactions that may be convenient in proximity to conventional social media interactions, potentially aiding in the adoption and the ease of use of the system. It should be understood that the present disclosure may be specifically configured to take advantage of time spent on personal social media interactions, in order to advance promotional objectives.

Further, it may be desirable to leverage the popularity of existing social networking platforms by implementing the system within an existing social networking platform such as Facebook™ or LinkedIn™, in the manner that is described. The present disclosure references in a number of its aspects Facebook as a particular example of implementation of the present disclosure. It should be understood that the present disclosure is not limited to integration with any particular third party social networking platform.

### Architecture/System Description

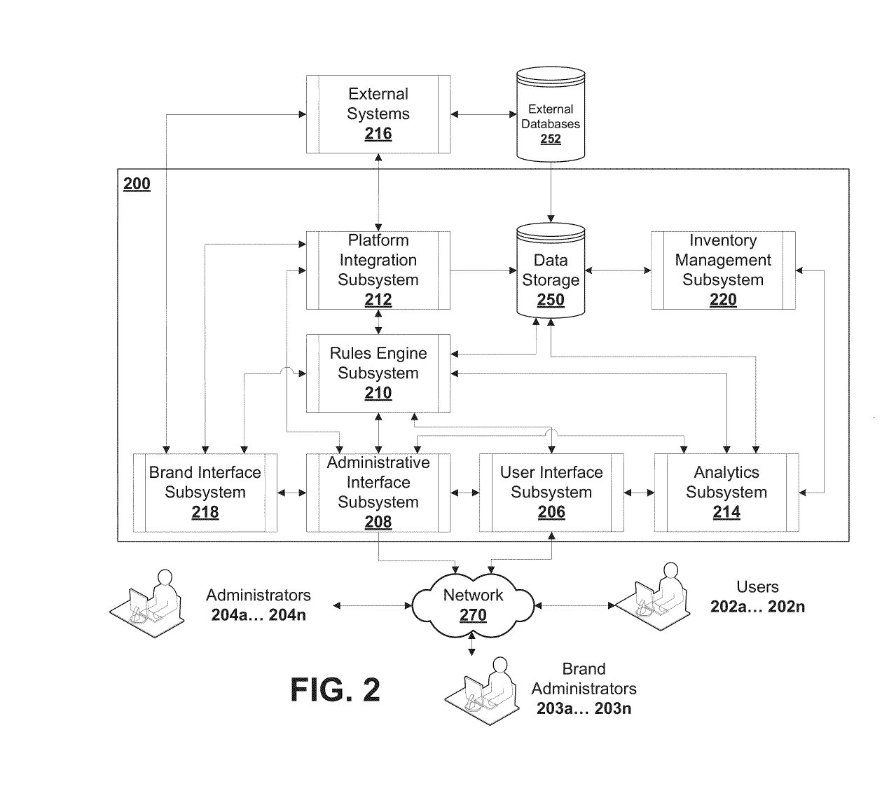

Referring to FIG. 2, FIG. 2 provides a high-level block schematic of a campaign/promotional offer management and/or distribution system 200, according to some embodiments.

The system 200 may be comprised of user interface subsystem 206, administrative interface subsystem 208; rules engine subsystem 210, platform integration subsystem 212, analytics subsystem 214, brand interface subsystem 218, inventory management subsystem 220 and data storage 250.

The system 200 may be comprised of one or more servers having one or more processors, operating in conjunction with one or more computer-readable storage media, configured to provide backend services, such as data processing, data storage, data backup, data hosting, among others. Each of these subsystems may be implemented using one or more modules comprising instruction sets executed on one or more processors.

The user interface subsystem 206 may be configured to provide one or more user interfaces to one or more users 202a . . . 202n through network 270. The user interface subsystem 206 may, in some embodiments, interoperate with one or more external systems 216 through the platform integration subsystem 212 in providing interfaces to users 202a . . . 202n. For example, the user interface subsystem 206 may be configured to provide various interface elements which may be rendered by an external system 216 before presentation to users 202a . . . 202n. The user interface subsystem 206 may further be configured to allow users 202a . . . 202n the ability to interact with the system by providing various elements of information, such as the ability to log into to view current promotional offers, to select promotional offers, to broadcast information about their promotional offers on various social media platforms, to share promotional offers, to review promotional offers, etc.

In some embodiments, the user interface subsystem 206 may include a shopping cart and/or other e-commerce functionality, where a user may be charged as part of a promotional offer (e.g. purchase a product at a discount).

The user interface subsystem 206 may develop an electronic user profile for each of the one or more users, which may be monitored and/or updated from time to time. This user profile may include various elements of information that are known about the user (e.g., the user inputs the information or accesses the system using various channels, the user utilizes a certain set of social networking platforms), inferred about the user (e.g., because the user has tried to redeem a code found in a Men's Fashion magazine, the user may be a male between the ages of 18-34 having an interest in skateboarding fashion and of a particular demographic), etc.

The user profile may be associated with information, such as information associated with loyalty programs, etc. The user profile may also track various purchasing behaviors and prior uses and interactions with the system.

The user profile may include information stored about the user as obtained from various sensors associated with and/or residing in a user's computing device. For example, a smartphone's GPS, Wifi connection records (e.g., nearby network signals, store-associated Wifi connections), cellular tower connection records (e.g., for triangulation or for determining last-known-access-point), etc., may also be used to determine information about the user to be stored on the user profile.

In some embodiments, the user profile also includes association information stored as contact information with other contacts (e.g., determining phone numbers, addresses, locations,

The user profile may be used, for example, in determining eligibility for receiving promotional offers (e.g., product samples and/or coupons) through the application of various rules.

The user profile may indicate a particular desirability of a user, from the perspective of an advertiser. For example, if the user profile indicates that the user is a highly influential blogger (e.g., high readership, large number of postings), an active user of social media platforms (e.g., large number of “friends” in a target demographic), or an active user of review platforms (e.g., posts highly influential reviews on food websites) the user may be more desirable and therefore may be provided more valuable promotional offers.

The user profile and/or user interface subsystem 206 may be configured to receive and/or utilize location information gathered from the individual (e.g., automatically, electronically, or manually input) to conduct various types of analyses, including determining where an individual lives, what stores are nearby, associating location data and user profiles with purchase behavior, etc. The location information may also be processed by the user interface subsystem 206 to generate and/or associate demographic information to the user profile based on detected location information and/or patterns of location information. For example, the location information may be utilized to determine that an individual is often located around a particular gentrifying neighborhood and the system may be configured to apply various rules to develop a probabilistic model in determining that the individual may be more interested in artisanal products and/or natural products as compared to another individual.

The user interface subsystem 206 may also be configured, in conjunction with the rules engine subsystem, to dynamically generate a score for an individual that may be representative of an economic score (e.g., a potential “future revenue” score, a potential “future profit” score) for the individual based on identified information and/or behavior trends.

For example, an individual may be identified as being part of a demographic where there are many repeat yet price conscious customers. This information may be utilized with a model to estimate, for example, the potential future revenue based on known information. As more information is received, the model may be re-run or updated such that the “future revenue” score is refined over time.

The “future revenue” score may be utilized in various embodiments, for example, as an input parameter into the rules engine subsystem 210 so that it is a factor that is utilized to determine eligibility for a particular promotional offer, or to decide between which promotional offer to provide. For example, a female shopper between the age of 40-55 who appears to work in a highly paying industry, has multiple magazine subscriptions, and has a purchase history of following up promotional offers (e.g., samples) by buying products may be eligible for particularly expensive promotional offers (e.g., samples) as it may make more financial sense for a company to provide her with a sample in the hopes that this will continue to encourage her loyal purchasing behavior.

In an example embodiment, the “future revenue” score is used as a factor in determining eligibility for promotional offers and the system may be configured to receive as an input a cost score (e.g., actual cost, imputed cost, actual cost with shipping, actual cost with overhead) related to a particular promotional offer and the rules engine subsystem 210 may provide offers only when the “future revenue” score is at least greater than a multiple of the cost score. For example, an estimated “future profit” score may be derived by subtracting the cost score from the “future revenue” score.

The “future revenue” score of a particular individual may also be influenced by the connections and/or associations an individual may have with others. For example, an individual who is particularly well connected or connected to high net worth individuals may also be provided a very high “future revenue” score in addition to the known information in the individual's user profile.

Where the availability of promotional offers is constrained, an administrator may configure the system such that eligibility criteria is automatically adjusted based on multiples of the “future profit” score and/or various cut off points.

As an example, when there are 10,000 available skin cream samples that have an associated cost score of $10 (e.g., the materials cost $5 and distribution/overhead costs $5), the system may be configured with a rule such that only individuals having “future profit” scores (e.g., estimated scores based on known information) greater than $15 will be provided samples.

However, as the sample inventory depletes to 1,000 available samples, the system may implement a rule wherein only those individuals having “future profit” scores greater than $50 will be provided samples.

Conversely, if a shipment of inventory samples is provided, raising the inventory levels to 1,500 available samples, the rule may be automatically adjusted to individuals having “future profit” scores greater than $20.

There may be other factors for automatic adjustment of pricing and/or cut-off points, for example, if a large number of invites have been sent out (but not yet redeemed), the system may be configured to apply a heuristic or an estimated uptake rate to the invites to determine how many potential promotional offers will be redeemed. This value may be used to modify a known value of inventory such that a more accurate inventory status may be provided, taking into consideration offers that have been distributed but not redeemed.

Similarly, the cut-off “future profit” scores required for an offer may be adjusted based on other factors, such as the popularity of a particular sampling page (e.g., the page has 5 MM unique visitors), the number of times a sampling page has been shared (e.g., tweeted, messaged, posted, discussed), or a combination thereof.

Network 270 may be any type of network, including, but not limited to, the internet, various intranets, wireless connections, wired connections, etc.

The administrative interface subsystem 208 may be configured to provide one or more administrative interfaces to one or more administrators 204a . . . 204n. The administrative interface subsystem 208 may be configured to interoperate with the rules engine subsystem 210 in the definition, monitoring and/or tracking of the one or more rules related to the operation of the system 200. For example, the administrative interface subsystem 208 may be utilized to define rules that restrict promotional offers to be provided only to particular demographics, etc.

In some embodiments, the administrative interface subsystem 208 may be configurable to provide a dashboard for the management and control of various administrative functions for one or more administrators 204a . . . 204n through a network 270. The dashboard may be configured to provide various decision support functionalities, and may interoperate with analytics subsystem 214.

The administrative interface subsystem 208 may be configured to interoperate with the analytics subsystem 214 to provide various types of decision support, and may base its decision support on variables that identify information such as the campaign objectives, target market, redemption period, redemption method, level of experience of administrator (e.g. beginner, pro, expert), etc.

The administrative interface subsystem 208 may, in some embodiments, be provided through the platform integration subsystem 212 through one or more external systems 216. For example, the dashboard may be provided through integration with a social media platform for ease of use. The administrative interface subsystem 208 may also be integrated with one or more external systems 216 to provide functionality to control and/or manage various elements associated with one or more campaigns that may be conducted through one or more external systems 216. For example, a campaign may be required to obtain consent to request information from an external system, or have various permissions to conduct actions such as posting on walls, sending private messages, etc.

The administrative interface subsystem 208 may also be, for example, configured to provide information to an administrator such as a dashboard view of a promotional offer campaign, using the analytics subsystem to generate various reporting views showing, for example, a redemption rate (e.g., determine based on the rate of inventory outflow and/or invite sharing as compared to actual redemptions), as well as a redemption speed (e.g., comparing the time that an invite was provided and when the invite was redeemed). This information may be helpful in gauging, for example, the effectiveness of a particular campaign, etc.

In some embodiments, the administrative interface subsystem 208 may also be configured to utilize aspects of the user profiles in generating statistics and usage information that may be displayed to an administrator or used in various machine learning aspects associated with the system, such as conducting an aggregation of the total “economic value” of the campaign by analyzing various economic scores associated with the user profiles (e.g., “future revenue” scores, “future profit” scores). This information may be utilized in the tailoring of future campaigns, for example, by recognizing that there is a high redemption rate every time a particular type of event occurs (e.g., twenty days before Christmas, graduation, a spike in newsletter registrations, an increase in “likes”, a “Wellness” week).

The rules engine subsystem 210 may be configured to enable the definition, deletion, modification, application, and/or monitoring of one or more rules. The one or more rules may constitute various elements of logic, and may also provide one or more triggers based on the occurrence/non-occurrence of various events. The rules engine subsystem 210 may be configured to interface with data storage 250 to determine whether triggers have been triggered, etc. Rules may be defined based on various types of information on users, administrators, campaign variables, promotional offers, etc. For example, a rule may be defined such that when low inventory levels are detected, the rule may alter the criteria for eligibility of promotional offers such that the promotional offers become more exclusive. Conversely, a rule may be defined such that when a certain period of time has elapsed and a promotional offer has not been redeemed at a sufficient rate, the promotional offer becomes less exclusive.

The rules may be based on various factors, such as the location of the user, the inventory levels of products and/or services, the timing of various promotions, etc. In some embodiments, the rules may also be provided in relation to specific advertising targets and objectives. For example, a rule may be provided such that a targeted user is requested to redeem a promotional offer in a specific store or location, or event, so that the targeted user is required to physically access the store or location.

The rules may determine how a promotional offer is provided, for example, including varying the contents of the promotion offer (e.g., providing an additional sample of a hand cream to a particularly desirable user), the type of promotional offer (e.g., providing a sample as opposed to a coupon), the duration of availability of the promotional offer (e.g., availability for two weeks), and the ability to share and/or distribute the promotional offer (e.g., ability to share to 10 connections on social media platforms).

As an example, the rules may be used to control advertising campaigns where promotional offers are provided and/or distributed. A sample advertising campaign may seek to model and/or determine the probable success of various distribution models and may apply one or more rules to distinguish and/or delineate users to determine various aspects of information related to the success and/or failure of various campaign methods and characteristics. For example, the rules may be designed in combination with various analytical reports and probabilistic models to determine which promotional offers were most effective, and which promotional offers were the least effective, comparing the offers and/or campaigns in relation to their specific characteristics. Offer types and characteristics for one user audience may not translate into success for another user audience, and the information may be used to help tweak future campaigns.

In some embodiments, the rules engine subsystem 210 may be configured to provide and/or implement a set of rules that may vary the functioning of the system as information regarding the promotional offers (e.g., the availability of promotional offers) is received, in real or near-real time. For example, inventory levels of promotional offers (e.g., physical samples, especially expensive and/or rare samples) can be dynamic, and it may be hard to predict interest levels in a promotional offer (e.g., a sample) prior to the conducting of a campaign. The interest levels may, for example, rise as the campaign increases in popularity.

Accordingly, demand may be dynamic and vary, in part on how much the campaign resonates to the target audience, including the promotional offer. Promotional offers are often a new product, or campaigns are based on targeting a product to a different market segment and/or using a different product or marketing message—this contributes in part to the fact that interest in the promotional item may be difficult to predict.

It may be important to ensure that inventory levels are sufficient to ensure timely delivery of the promotional item, otherwise for example the brand reputation of the product or its vendor may be affected negatively.

It may be advantageous therefore to monitor in real or near-real time the performance of the campaign, inventory levels and make changes programmatically to the campaign based on these criteria.

In some embodiments, the rules engine subsystem 210 may provide a set of rules that establish a threshold in which eligibility parameters should be changed, for example, based on the performance of similar campaigns, a determination that an inventory level (real or nominal) may have decreased beyond a certain level, a determination that there appears to be growing demand (e.g., through the detection of substantial page visit activity and/or “likes” of an organization's social media platform account), a high level of sharing activity (e.g., individuals are rapidly sharing promotional offers), a high level of redemptions, etc.

In some embodiments, the rules engine subsystem 210 may provide a set of rules that establish a first set of eligibility parameters, the eligibility parameters being based at least on the user specific information stored in the electronic user profiles and defining a subset of the one or more users.

This set of eligibility parameters may be used for automatically determining eligibility of the user to receive the one or more promotional offers based in part on characteristics stored within the electronic user profile corresponding to the user and the inventory levels of the one or more promotional offers.

Where the user is determined to be eligible to receive the one or more promotional offers, the rules engine subsystem 210 may cause the distribution of a first set of promotional offers to the user and where the user is determined not to be eligible to receive the one or more promotional offers, the rules engine subsystem 210 may cause the distribution of a second set of promotional offers to the user; wherein the first set of promotional offers is different than the second set of promotional offers. For example, the first set of promotional offers may be more commercially valuable (and therefore preferably allocated towards more desirable users) and the second set of promotional offers may be less commercially valuable. In some embodiments, the first set of promotional offers may include product samples, and the second set of promotional offers may include coupons.

The eligibility rules may also be dynamically altered, for example, in response to a greater or lower amount of available inventory/promotional offers, an elapsed time period, the occurrence (or non-occurrence of a particular event), the provisioning of promotional offers to friends/associates/connections of a particular user (e.g., a user was not initially eligible but since an eligible user had also shared the promotion to the user, the user is now eligible in view of a relaxed set of conditions for friends/associates/connections of an eligible user).

In one aspect, one or more thresholds may be established and/or determined. For example, these thresholds may be based on various criteria, such as the percentage of promotional offers remaining, the redemption rate of promotional offers, the number of unique visitors to a particular page, the number of promotional offers shared, the availability of shipping capabilities, time of campaign, etc. These thresholds may, for example, be pre-determined, or in some embodiments, various machine learning aspects may be used to tune these thresholds based on information available regarding prior campaigns.

In some embodiments, the thresholds may include determinations related to the economic indicators and/or metrics determined and/or otherwise associated with the individuals (e.g., as stored in their user profiles). For example, economic indicators may include a determined “potential revenue score”, a “potential profit score”, etc., and these economic indicators may be aggregated. There may be more than one threshold, for example, there may be tiers of thresholds where eligibility criteria is either restricted or relaxed, depending on determined supply and/or demand. For example, there may be varying degrees of changed eligibility parameters associated with each of the thresholds.

The thresholds may be determined such that these economic indicators may be optimized (e.g., to maximize potential revenue and/or potential profits) by using potential demand (e.g., as determined indirectly through the number of sharing occurrences, page impressions, redemption rate) to implement modified eligibility criteria at particular thresholds in view of supply. For example, if expected demand is far exceeding current supply, a determined demand threshold may be triggered and optimal eligibility criteria may be selected such that restrictiveness of the eligibility criteria may be matched with the expected demand, optimizing an economic factor, such as aggregate potential profits.

In some embodiments, the analytics subsystem 214 may be used to adjust eligibility dynamically to smooth fluctuations in redemption. For example, if the analytics subsystem 214 may be configured to track and/or monitor promotional offer redemptions and detect variations in redemption rate.

Where variations in redemption rate are detected, the analytics subsystem 214 may be configured to interoperate with the rules engine subsystem 210 in modifying eligibility criteria such that redemption rates may be smoothed out and/or controlled during a period of time. For example, an administrator or the system may be able to indicate/determine a “healthy” level of redemptions based, for example, on the availability of shipping means, production, shipment of supplies, etc., and the analytics subsystem 214 and rules engine subsystem 210 may be configured to apply various control feedback principles to vary the eligibility criteria associated with the promotional offers such that the redemption rate is increased and/or decreased in response to variations. In an embodiment, where the analytics subsystem 214 determines a slowdown in redemption rate, the rules engine subsystem 210 may apply a rule relaxing the eligibility criteria to an appropriate tier (e.g., if there are multiple tiers having different levels of “restrictiveness”). Conversely, in an embodiment where the analytics subsystem 214 determines a speed up (e.g., higher rate) in redemption rate (e.g., velocity or acceleration), the rules engine subsystem 210 may apply a rule tightening the eligibility criteria to an appropriate tier.

The rules engine subsystem 210 may be used to update the inventory levels based on the set of promotional offers distributed to the user and to determine whether the inventory levels of the one or more promotional offers will be reduced below a predefined threshold. Upon a determination that the inventory levels will be reduced below a predefined threshold, the rules engine subsystem 210 may establish a second, updated set of eligibility parameters defining a subset of the one or more users that is smaller than the subset defined by the first set of eligibility parameters.

The provisioning of the second set of eligibility parameters facilitates a reduced eligibility for promotional offers, which may assist with the management of dwindling supplies of promotional offers. For example, if the promotional offer is an expensive product sample, the eligibility criteria may be automatically adjusted to reflect the need to target more desirable users when inventory levels are reduced.

The platform integration subsystem 212 may be configured to provide interoperability and/or communication with various external systems 216, for example, various social media channels such as Facebook™, LinkedIn™, etc., and/or one or more newsletter services. External systems 216 may also include organizational systems, such as a branded company's internal brand management systems, inventory systems, newsletter systems, etc. External systems 216 may also include various user information databases, such as customer relationship management systems, online repositories of user information, user directories, etc.

The platform integration subsystem 212 may be configured to retrieve and/or otherwise provide an electronic listing of one or more other users connected with the user associated with each electronic user profile, and user characteristic information for each of the one or more other users. Other information may also be retrieved, such as what pages a user is associated and/or otherwise affiliated with (e.g., organization pages the user ‘likes’).

In some embodiments, the platform integration subsystem 212 may be configured to accept and/or validate unique URLs/codes for use with external systems 216. For example, a user may receive a unique URL from another interaction, such as in a flyer, which prompts the user to redeem the URL to receive a promotional offer from the system 200.

In some embodiments, the platform integration subsystem 212 may be configured to insert metadata tags (e.g., hashtags or named @ “tags”) automatically when generating a posting and/or message on a social media platform. The metadata tags may be based on the names of a top few connections who have not been invited (top based on their determined and/or probabilistic attractiveness to the campaign requirements), or to the names of the organization providing the promotional offer, etc. A potential benefit of such an approach may include the ability to automatically generate embedded invitations when an individual makes a posting on a social media platform.

In some embodiments, the platform integration subsystem 212 may be configured to detect various policies enforced by the one or more external systems, such as Facebook™ privacy settings. The platform integration subsystem 212 may interoperate with the rules engine subsystem to define rules such that alternate options may automatically be chosen and/or presented to the user where, for example, a recipient of a recommendation/an invite may have strict privacy policies set up that do not permit communications via particular methods. For example: a user's friend Jane does not allow for Facebook™ wall posts. The platform integration subsystem 212 may be configured detect such a setting through a monitoring rule, and a rule may be in place to suggest that the user send her the promotional offer via another delivery method, such as email or private message.

The platform integration subsystem 212 may include one or more application programmable interfaces (API) that provides communications means between various machines and/or systems. An API may be implemented via various technologies, such as Simple Object Access Protocol (SOAP), interfaces developing through exposing functionality using programming code, representational state transfer (REST adhering programming techniques), etc.

The analytics subsystem 214 may be configured to provide analytical capabilities based upon data stored in data storage 250, such as the ability to generate and/or run reports, the ability to provide statistical information recorded through various interactions with the system, etc. The analytics subsystem 214 may also utilize information stored in data storage 250 and pulled from one or more external databases 252, such as information on general statistics, information from other brand campaigns that may not be directly linked to the system, etc. The analytics subsystem 214, in some embodiments, may be configured to provide functionality for decision support, through, for example, analyzing key performance indicators from one or more successful promotional campaigns in contrast to less successful promotional campaigns.

The analytics subsystem 214 may be configured such that comparisons may be generated in relation to the cost and/or supply levels of various promotional offers. For example, the analytics subsystem 214 may track the revenues associated with a user and compare the revenues against the cost of providing a promotional offer to the user, as well as the probabilistic return based on an analysis of an aggregate of users (e.g., not all users who receive product samples will return to purchase a product). Similarly, the analytics subsystem 214 may also track the redemption rate of promotional offers that have been issued by the system.

The analytics subsystem 214 may be used to determine various aspects of information about users, such as where users are interacting with the system, how they are accessing the system, the types of devices the users are using, etc. The analytics subsystem 214 may also be used to conduct various filtering, aggregation and/or analysis, such as listing top referring brands, competitors, retailers, age, etc.

Various algorithms may be used to aggregating information and determining, for example, whether a particular account on a social media networking platform is a retailer or a brand that is directly related to business of client, and may use this information to improve demographic targeting of users who may be associated with the account.

In some embodiments, decision support may include machine learning for the extraction and/or identification of leading practices, providing decision support responsive to the type of parameters of the campaign (e.g., target audience, product/service type, campaign objectives), decision support compared against leading practices and/or metrics (e.g., your campaign is underperforming comparing to the industry average, the system offers a suggestion of utilizing another channel or extending the campaign), etc.

The brand interface subsystem 218 may be configured to provide a platform where brand administrators 203a . . . 203n can perform various tasks, such as creating, modifying, deleting and/or customizing their one or more campaigns; organizing promotional offers under one or more campaigns; defining and/or applying rules in relation to various promotional offers and/or campaigns; purchasing credit for use with the system 200 (e.g., purchasing various functionality within the system 200), setting up reporting and/or tracking analytics; receiving decision support from the analytics subsystem 214; among others.

In some embodiments, the brand interface subsystem 218 may be provisioned through one or more external systems 216, such as being provisioned through a Facebook™ application. In some embodiments, the brand interface subsystem 218 may be implemented as a stand-alone system. In some embodiments, the brand interface subsystem 218 operates in conjunction with the administrative interface subsystem 208 and/or the functionality of both systems may be provided through the same interface.

In some embodiments, the brand interface subsystem 218 may be configured to support e-commerce functionality in providing one or more brand administrators the ability to conduct transactions and/or to purchase functionality with the system 200. The brand interface subsystem 218 may, for example, permit the purchase and/or spend of campaign credit, collect one-time payments, set up recurring payments, etc. Services may be charged through various models, such as the number of promotional offers provisioned, the number of promotional offers sent, the number of promotional offers redeemed, a flat fee, a subscription model, a volume model, and/or any combination of various models. In some embodiments, the e-commerce functionality may be operable with a shopping cart-type interface. In some embodiments, the e-commerce functionality may enable the unlocking and/or purchasing of features by one or more brand administrators (e.g., providing support for rules indicating various reward levels may be purchased).

The brand interface subsystem 218 may be configured, based on one or more rules, to send out notifications when campaign credit is running low, for example, and/or provide various analytics in helping one or more brand administrators in deciding what type of plan and/or how much campaign credit a particular campaign is expected to cost.

The inventory management system 220 may be configured to track current (e.g., warehouse storage levels) and/or future (e.g., expected shipments, manufacturing availability, cancellations of existing orders) inventory levels of various products and/or services. Data and information from external databases 252 may also be utilized in the tracking of inventory levels. Inventory levels may be periodically monitored as one or more promotional offers are distributed through various channels.

The information determined by the inventory management system 220 may be used, in part, for determining eligibility criteria for the provisioning of one or more promotional offers. For example, if inventory is determined to be at a high level, the threshold of user desirability may be lower (e.g., causing more users to receive promotional offers where a sample is provided), and as inventory levels decrease, the threshold of user desirability may increase accordingly (e.g., causing less users to receive promotional offers where a sample is provided). This information may, for example, be used in determining what type of promotional offer is made (e.g., providing a physical sample or a coupon), whether a user is able to receive an offer that is sharable, and the number of other users a user is able to share the offer with.

The data storage 250 may include various types of non-transitory computer readable media, and may, in some embodiments, be a distributed networking implementation, such as a cloud computing implementation. The data storage 250 may include various types of databases and/or storage media, such as SQL servers, flat files, Microsoft Excel™ files, etc. Information may be stored as records and may, in some embodiments, have one or more relationships defined between various records. In some embodiments, the data storage 250 may preprocess and/or transform, extract or load the data for data mining and/or data warehousing purposes.

### Management/Distribution of Promotional Offers

In some embodiments, the system may be configured for the management, analysis, and/or the distribution of one or more promotional offers. The promotional offers may include a variety of goods, services, and/or offers. For example, the promotional offers may include online coupons, physical coupons, physical samples, virtual samples, exclusive access, reservations, rebates, contests, premium offers, access to special sales events, etc. A promotional offer may also include more than one good, service and/or offer. The events may be digital or physical events, and may include other interface aspects such as a RSVP page having calendars of events from different brands, etc.

Management of one or more promotional offers may include activities related to the particular management of one or more promotional offers, which also may be organized under, related with and/or associated with one or more campaigns. These activities may include creating, controlling, tracking, and/or developing/applying rules, etc. There may be various management activities during the lifecycle of a particular promotional offer and/or campaign.

Distribution of one or more promotional offers may include activities related to providing the one or more promotional offers to one or more users and/or the general public. Distribution, in some embodiments, may be virtual and/or physical, and may broadly include non-traditional types of marketing campaigns, such as online coupons, exclusive access, contests, etc.

In some embodiments, administrators may desire to limit the distribution of one or more promotional offers to one or more subset of users, for various reasons, such as to maintain exclusivity, to reward loyalty, to develop publicity through word of mouth, to reach only a particular group that may be more influential or more affluent, etc.

The desire to limit the distribution of promotional offers may also be due to the scarcity of product and/or resources. For example, if a company seeking to promote a new shampoo only has 50,000 samples, it may be particularly advantageous to utilize the system to provide the samples to a targeted group of users most likely to help develop the brand after receiving the samples. Conversely, the company may seek to avoid providing samples, which may be costly, to demographics it is not targeting. For example, if a company were promoting female hygienic products, the company may desire not to promote its product to men.

A potential advantage of such an implementation may be an increased ability to intelligently target the distribution of promotional offer to a set of individuals based on a set of defined characteristics.

This may be advantageous relative to, for example, distribution broadly to the public, where an organization may have little control over who receives their offer and may thus be needlessly providing offers to individuals who may not be a good target market for the particular offer. Such advantage may be particularly important for expensive and/or scarce offers.

Further, in some embodiments, the system may be configured such that one or more users may be able to invite one or more other users to participate in the promotion.

The ability of the system, in some embodiments, to provide targeted distribution and/or a referral based distribution may be advantageous, for example, in developing word of mouth, buzz for a product, a feeling of exclusivity, a feeling of selectivity, etc.

The system may be configured to conduct the distribution of the promotional offers as one or more promotional campaigns, potentially providing a further ease of management and/or coordination. Further, in some embodiments, the system may be configured to provide analytical tools and/or the ability for one or more administrators to actively and/or passively modify the promotional campaigns depending on various attributes of the promotional campaigns and/or other external variables.

The distribution of promotional offers may be dynamically provisioned based on various factors, such as the availability of promotional offers (e.g., inventory levels for product samples), the apparent desirability of a particular user/recipient, campaign rules (e.g., more promotional offers are targeted during a particular time duration or timeframe), etc.

The availability and/or distribution may be determined by a system that adjusts the eligibility of users (e.g., modifying the eligibility criteria) as various information is provided to the system (e.g., physical inventory levels are decreasing, expected demand will surpass expected supply), etc.

The system may be configured to assess current and/or expected supply and demand and adjust eligibility criteria accordingly.

In some embodiments, the system may be further configured to define/provide/monitor/apply a set of rules, which may be driven by a rules engine. For example, the system may have a rule defined by an administrator to be more selective in terms of user demographic for a particular campaign when inventory supplies for the promotional offer become low, etc.

Other potential rules may include rules for operating a campaign during a particular period of time, expanding a campaign if it becomes very popular, sending one or more notifications when particular conditions have been met, providing tiered offers depending on one or more characteristics of a user, etc.

In some embodiments, after a promotional offer has been redeemed and/or transmitted, the system may be configured to send a notification to a user requesting a review and/or to share information about the promotional offer and/or its associated brand.

In some embodiments, promotional offers may be spread through various physical publications, such as print (e.g., magazines/newspapers, etc. The system may be configured to use various encoding technologies (e.g., quick reaction (QR) code technology) that may be used by readers of a magazine to gain access to a sampling event and/or promotion provided by the system (e.g., hosted either on a website through a user interface, on a mobile application or a brand's social media pages).

For example, a reader of a magazine may be provided a QR code, and the reader may utilize the QR code to access a physical sampling event through integration of the system with a social network (e.g., Facebook™). As readers of a magazine and/or other publication may have various inferable demographic profile information, the system may associate one or more aspects to the profile of a user redeeming a promotional offer provided in a magazine. As an example, the name of a user may be initially known by the system, and if the user redeems a promotional offer in a particular section of a magazine, information may be linked to the user's profile (e.g., as metadata) indicating probable demographic information (e.g., sex, age, socioeconomic status), etc. Other information may also be derived about the individual, for example, as the individual may need to connect with a verified account, such an account on a social media platform (e.g., a Facebook™ account), a loyalty program account or an account associated with the system.

The captured information for a particular user (e.g., demographic, channel) may be used in conjunction with other information, such as inventory levels, etc., to determine various aspects of the promotional offer being provided to the user. For example, if the user is determined to be particularly desirable and sufficient inventory remains, the user may be provided with an offer to redeem a sample and a code to share to a friend. If the user is not particularly desirable and inventory levels are low, the user may instead be provided a coupon.

In some embodiments, promotional offers may be provided as part of product packaging such that users who consumed a product may be able to either claim a sample for another product category and/or recommend that product to others (e.g., friends), for example, by accessing the system through a URL hidden on a QR code.

There may be, for example, promotional offers provided through in-aisle advertisements. For example, a shopper at a physical store may be prompted to provide information through a code and/or URL provided on shelving in a store.

Similarly, probabilistic information may be provided, inferred, and/or determined through characteristics of the in-store advertisement (e.g., placement, location, store section), which may then be associated with the user to determine and/or update the user's profile with captured and/or probabilistic information.

In some embodiments, promotional offers may be provided through online display advertisements. For example, advertisements may be provided by various third parties and/or advertising networks such that advertisements may be displayed on targeted websites. These advertisements would link to a sampling event and/or promotion hosted by the system.

In some embodiments, promotional offers may be distributed through in-store (e.g., on products, on signage) or event-based advertisements. For example, a link, a URL, a QR code could be provided, etc.

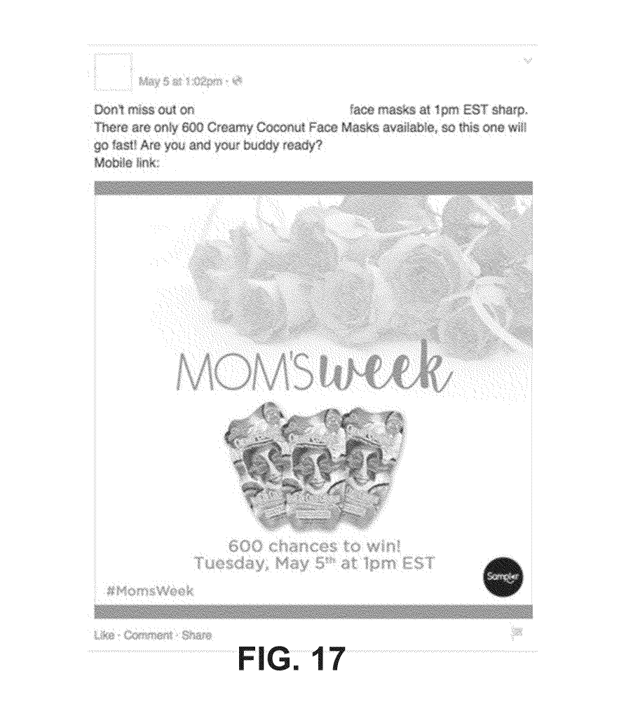

FIG. 17 provides a sample screenshot of a sample advertisement on a social networking platform containing an embedded uniform resource locator, according to some embodiments.

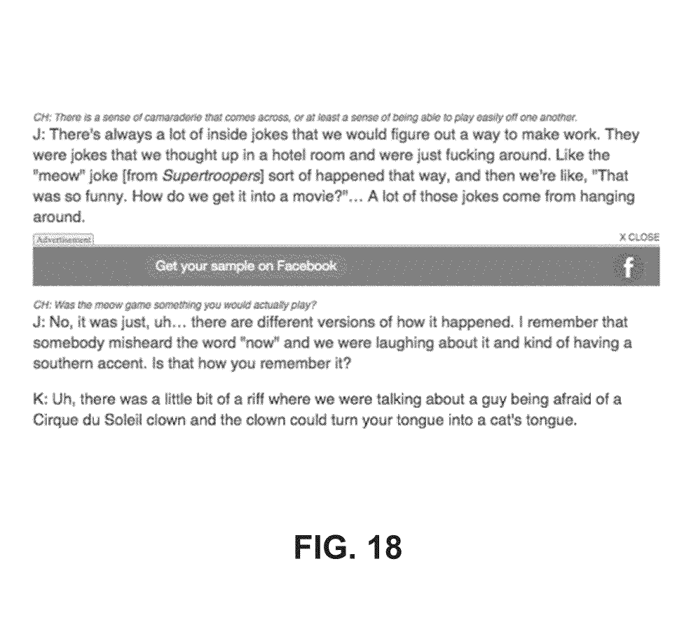

FIG. 18 provides a sample screenshot of the sample advertisement on a website containing an embedded uniform resource locator, according to some embodiments.

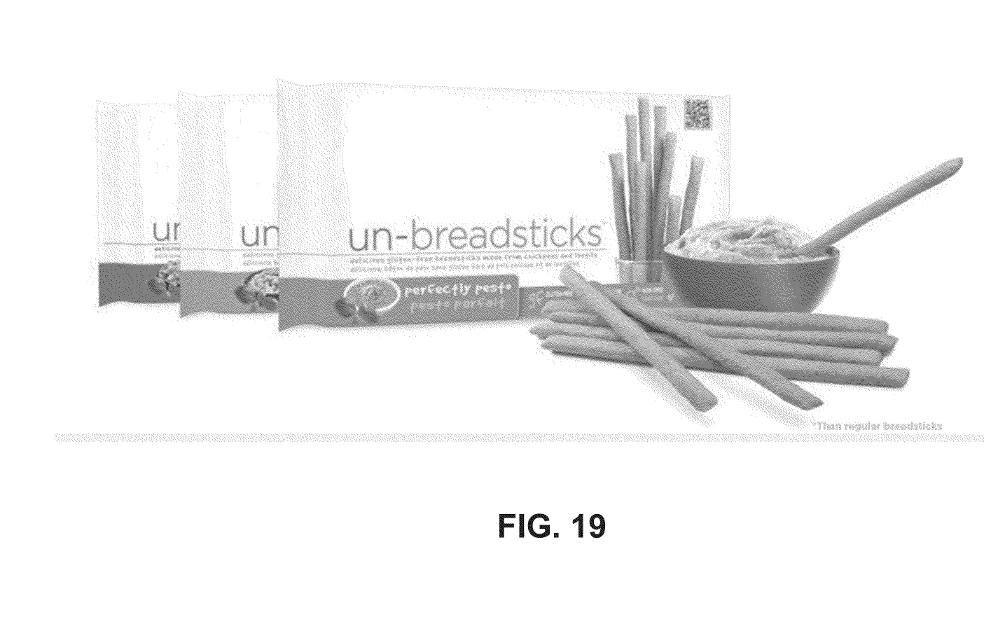

FIG. 19 provides a sample screenshot of product packaging containing an embedded quick response code, according to some embodiments.

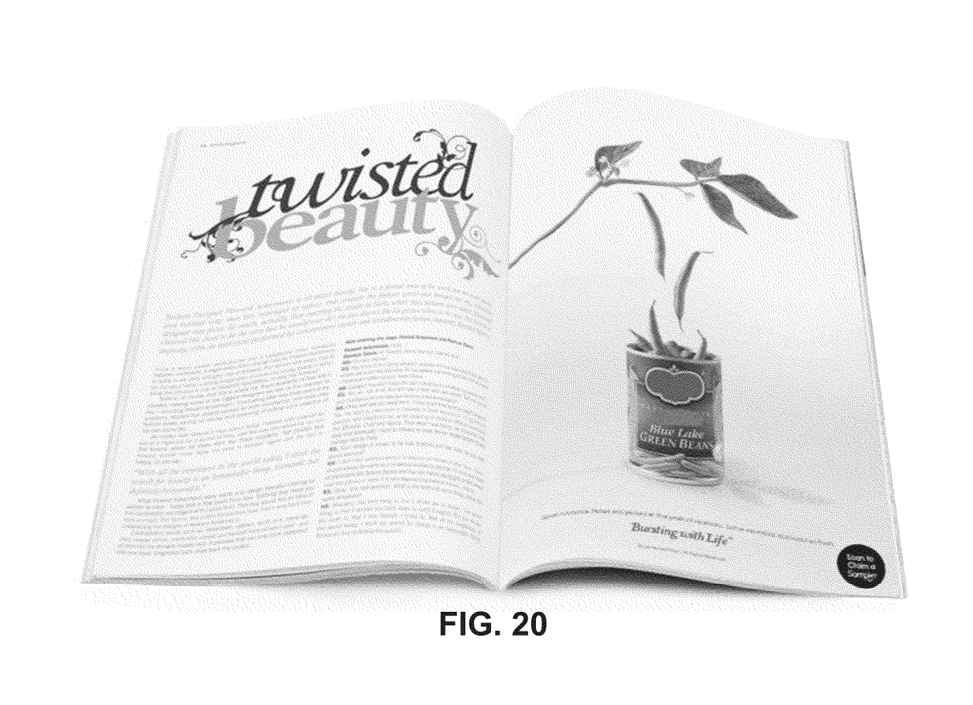

FIG. 20 provides a sample screenshot of a magazine page containing an embedded quick response code, according to some embodiments.

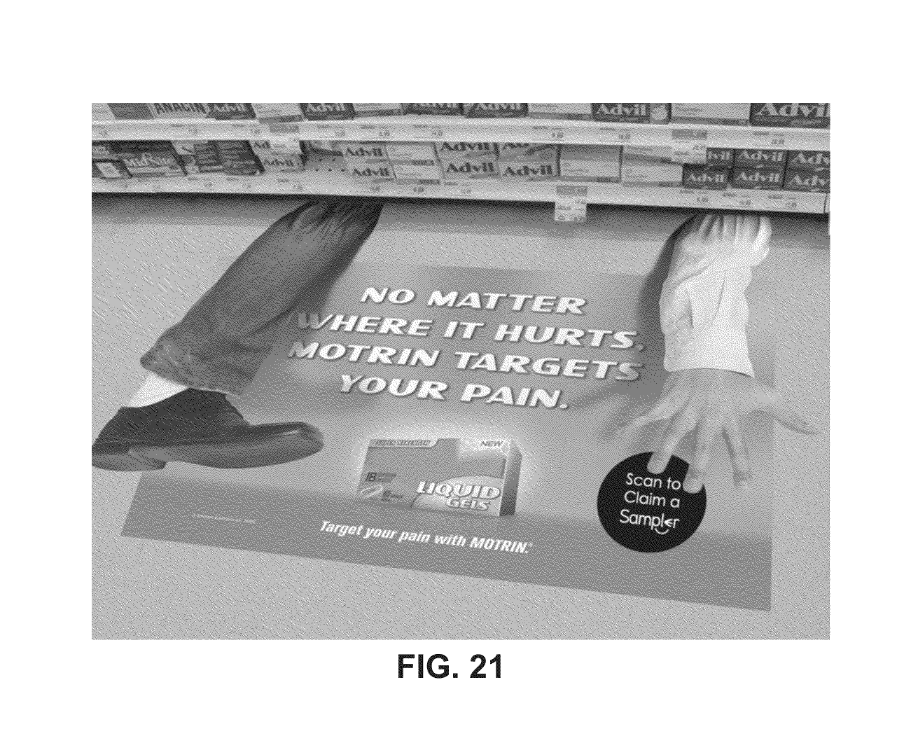

FIG. 21 provides sample screenshots an in-store advertisement containing an embedded quick response code, according to some embodiments.

### User Targeting

In some embodiments, the system may be configured to only allow a subset of users to access the one or more promotional offers. The subset of users may be defined by the administrators by the definition of one or more rules, which may be applied and/or monitored by the rules engine. For example, the subset of users may only include users who fit a particular demographic profile, were originally fans of a Facebook™ page, are based in a particular location, etc.

In some embodiments, the system may be configured with one or more rules that define how one or more users and/or one or more contacts of one or more users may be ranked/prioritized based upon their characteristics. For example, in a campaign where the promotional offer is a baseball, a brand manager may find it useful to have one or more rules set to rank users based on their desirability with respect to demographics. When the system is generating a list of contacts, for example, to provide options for inviting a user's friends, the list of contacts may also be ranked in priority order.

In some embodiments, the subset of users also be limited by unique URLs that may be sent by one or more external systems and/or generated by the system.

In some embodiments, the system may be configured to provide functionality for targeted recommendations to be sent to one or more contacts associated with one or more users.

The set of one or more contacts may be derived from various information associated with the one or more users, and in some embodiments, the system may be configured to retrieve the set of one or more contacts from various internal systems, external systems and/or databases, such as contact lists, any information known by the system about a particular user, social media friends lists, and/or any other type of contact with whom the user has had interactions with (e.g., people that have retweeted or used a particular hash tag).

For example, the system may provide the ability for users to use “peer recommendations” whereby existing users/fans of various brands may be invited to recommend a product sample or coupon to friends that fit a certain demographic.

This demographic may be predetermined using a set of rules and in some embodiments, may also dynamically change depending on various variables, such as the amount of remaining inventory (e.g., the criteria for the demographic may become stricter as there are less and less products remaining).

In some embodiments, the system may be configured to identify a subset from the set of one or more contacts depending on one or more rules defined by one or more administrators, to, for example, target a particular demographic and/or type of individual.

The one or more rules utilized for the identification of the subset may include various types of rules, such as filtering (e.g., no men), scoring (e.g., only those with an aggregate score >10, where criteria may include elements such as age, hair color, etc.).

The user interface may be configured to show a list of contacts that the user can send referrals, and/or send offers to.

In some embodiments, the system may be configured such that only the subset of contacts identified (e.g., eligible contacts) may be available for selection by the user. For example, if a customer who has received a shampoo sample through the system wishes to send out samples to his/her friends, the system may apply rules to determine which contacts of that customer fit the criteria, and then only display that list of contacts to the user.

The system may also be configured to target subsets of individuals to distribute promotional offers to, even in the absence of referrals. For example, the system may be configured to provide samples to all Facebook™ fans of a particular page and/or product. Such an implementation may be advantageous as a loyalty program, for example.

The rules for determining which contacts fit the criteria may be developed for various types of logic, for example, how long a contact has been a fan of a particular brand's Facebook™ fan page. If that contact was not a fan before the promotion started, the system may be configured such that that contact may not be allowed to send a recommendation to friends or to claim a sample for themselves.

In some embodiments, one or more rules may be defined for the validation of one or more characteristics associated with one or more users. Validation of the one or more characteristics may be conducted for various reasons, for example, verifying that a user or potential user's account is actually used by a person, in contrast to inactive accounts, fake accounts, accounts opened by malicious users, etc. Validation may be conducted through, for example, defining and/or applying a rule where there is a minimum threshold on the number of contacts (e.g., Facebook™ friends, LinkedIn contacts, etc.) associated with a user, and/or various other criteria. Validation may be advantageous in potentially increasing the number of promotional offers provided to desirable individuals, as opposed to accounts not associated with individuals and/or accounts created with malicious purposes.

### Campaign Management System

The system may be configured to provide campaign management features, for example, analytic features, promotional offer tracking features, delivery tracking features, campaign coordination features, etc.

The various campaign management features may further be integrated into various external systems, such as company systems, customer relationship management systems, inventory systems, social media channels, e-commerce channels and/or e-mail management systems.

In some embodiments, the system may be configured to provide an interface, such as a graphical user interface, or an API, for interactions with one or more administrators. For example, the system may be configured to provide administrators to create, manage, delete, and/or modify campaigns.

In some embodiments, the system may be configured to provide administrators the ability to create/define/modify/delete various rules that may be utilized by the system. For example, administrators may be able to set up a campaign that may be time limited, or becomes more exclusive as the inventory of promotional offers begins to decrease. In some embodiments, the administrators may be able to develop rules that apply between campaigns, for example, the ability to indicate that if a sample is requested from a campaign relating to one product, then soliciting the user with an offer from a related product.

A potential advantage to such an implementation would be the ability to enable cross-selling and/or intelligently utilize information received from one campaign in another campaign.

In some embodiments, the system may be configured to provide decision support tools for the administrators; these decision support tools may, for example, interface with the analytics and/or data received by the system. For example, the system may indicate to the administrator that a particular promotional offer may not be performing as well as the others, and may provide information such as traditionally promotional offers displayed on a page where users would have to scroll down to reach have not been as popular, etc.

In some embodiments, information from the system may be utilized to communicate with a suggestion engine, that through the dashboard, enables administrators to not just access a template for a campaign for one or more promotional offerings, but may also suggest certain key parameters such as target demographic, segmentation of target groups, ideal social profile attributes, etc.

In some embodiments, the system may be configured to provide a dashboard-type user interface that may enable administrators to design, and manage their campaigns. The interface may provide various tools for design, which may include the customization of one or more design elements, the customization of text, the customization of layouts, the ability to attach one or more media elements to a campaign, etc. The interface may also include one or more reporting tools for tracking performance of various campaign elements, such as the distribution of samples.

The interface may also be configured to provide functionality for administrators to set parameters, define rules, such as the redemption period, period of time for which the target “liked” a page, and/or other thresholds for redeeming the offer (including various characteristics of the user, etc.). In some embodiments, rules and parameters may be implemented for the identification of friends of a particular user, etc. For example, a user may wish to send product samples to one or more other potential users, such as his/her friends, and the system may be configured to apply a set to select a subset of eligible users from his/her friends for the promotion.

The interface may also be configured to provide the administrator the ability to define certain promotional offer options that the user would be able to select from, which may be advantageous, for example, to improve the interest of the friend of a particular user.

The administrator interface subsystem may be configured to provide access to administrators to access data, download data, and/or manipulate data, including data such as product shipping lists; newsletter registration lists; and/or excel version of analytics dashboard so that administrators may use data for their own calculations/reporting, among others.

### Campaign Analysis

In some embodiments, the system may be configured to provide analytical tools to analyze gathered, tracked and/or received information. For example, the analytical tools may provide aggregate information, such as number of samples requested during a particular period of time; demographic information, number of samples requested by women between the ages of 15-23, etc., but may also be configured to provide and/or analyze information based on the particular usage behaviors of one or more users.

Various attributes/events of campaigns may be logged as they are executed, and may be stored to a database. The system may be configured to include an analytics engine may receive the information and/or may be configured to enable analysis of campaigns, for example, to analyze performance. In some embodiments, the system may be configured to utilize various machine learning techniques, such as neural networks, hidden Markov models, etc. to discover trends and/or parameters of successful campaigns.

For example, the analytical tools may be configured to track information such as the amount of time users spend on a particular page, how often a particular button was clicked, the positioning of mouse cursors, how much time was spent selecting other friends to send offers to, etc.

The information gathered may be processed in various ways, using various statistical methods and/or aggregation methods. In some embodiments, the information may be stored one or more non-transitory computer readable media, such as one or more databases, etc., and may be configured to interface with one or more external systems. In some further embodiments, the information may be stored within a data warehouse where various processing operations may be conducted to the information to prepare it for various types of processing, extraction, transformation and/or loading.

In some embodiments, the system may be configured to provide and/or compare the data collected for a particular campaign and/or promotional offer against industry averages. This functionality may be advantageous, for example, in providing decision support capabilities to one or more administrators.

In some embodiments, the system may be configured to track the change in attributes for a particular contact, administrator, and/or user. For example, the system may be able to track and/or report on the number of users had started liking pages from the brand when they were selected to receive samples. Such information could be provided in various formats, such as tables, aggregated data, charts, etc.

In some embodiments, the analytics subsystem may be configured to provide at least one of the following metrics: Total # of impressions created by social media posts; identification of who their most valuable users are based on how many recommendations they created and how many recommendations that created; how many new users did the promotion create; aggregated data regarding the average age, sex, location of users; how many of the users you targeted ‘like” a competitor; what are the most common interests (brands that users like) amongst all participants who sent or received an offer; the top 20 states in which users logged in to send or receive promotional offers; the top 20 cities in which users logged in to send or receive product samples; how many visits were received on desktop, mobile or tablet, etc.

Reminder Emails

The dashboard may be configured to send reminder emails automatically to senders whose friends still have not claimed a sample during a peer recommendation campaign, based on one or more rules as stored by the rules engine. In some embodiments, text may be pre-set for the emails but can also be edited.

User Look Up

The dashboard may include searching tools to provide potentially convenient methods to search for users who have signed up for one or more promotion offers. This feature may be advantageous in allowing customer service teams the ability to manage customer service requests. The user lookup feature may allow administrators to look users up by name of Facebook™ account URL and may show the status of each user's promotional offer order.

In some embodiments, the system may be configured to connect to various external systems, such as e-commerce platforms, to provide and/or share analytical information for particular users.

### Example Use Cases

The following use cases may be provided for illustrative, non-limiting purposes to help a reader understand some potential embodiments and/or implementations. There may be other uses cases, different use cases, less use cases, more use cases, etc., and the following should not be interpreted as definitive or limiting.

Targeting Example—Selective Sending of Invitations

The system may be configured to help one or more branded companies target the particular customer groups using “Peer Recommendation” techniques. In this example, existing fans of brands may be invited to recommend a product sample or coupon to friends that may fit a certain demographic. The system may be configured to allow brands to encourage their existing fans to claim a sample for themselves as part of a loyalty campaign.

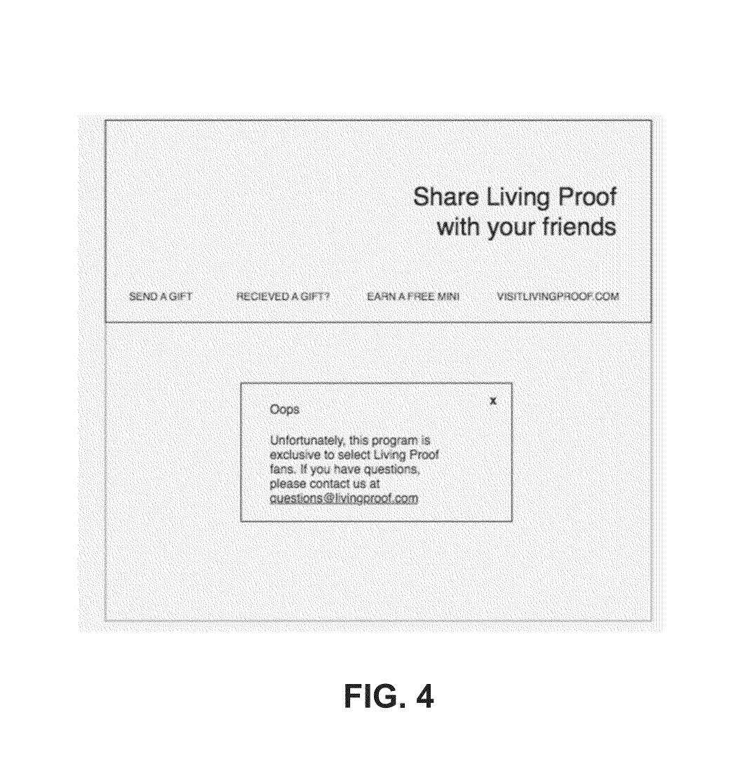

When a potential user logs in the system, the system can verify how long they have been a fan of the brand's Facebook™ fan page. If they were not fans before the promotion started, the user may not be allowed to send a recommendation to friends or to claim a sample for themselves. FIG. 4 provides a sample screenshot of a page where a potential user is not allowed to send a recommendation or to claim a sample, according to some embodiments.

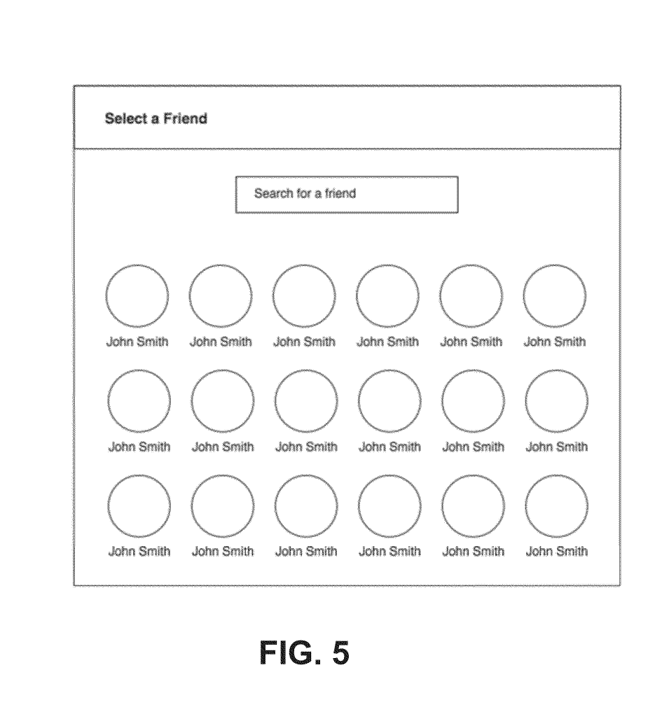

Once a user who is eligible to send a recommendation clicks on the “Send It” button and connects with their Facebook account, the system may be configured to load their contacts (e.g., their friends list) that match the targeting parameters (as may be defined through one or more rules) based on age, sex, location and/or interests set by one or more administrators. These users may be considered ‘senders’. In some embodiments, the sender may only be able to select friends that match that demographic. FIG. 5 provides a sample screenshot of an interface where only friends that matched a set of demographic criteria are shown, according to some embodiments.

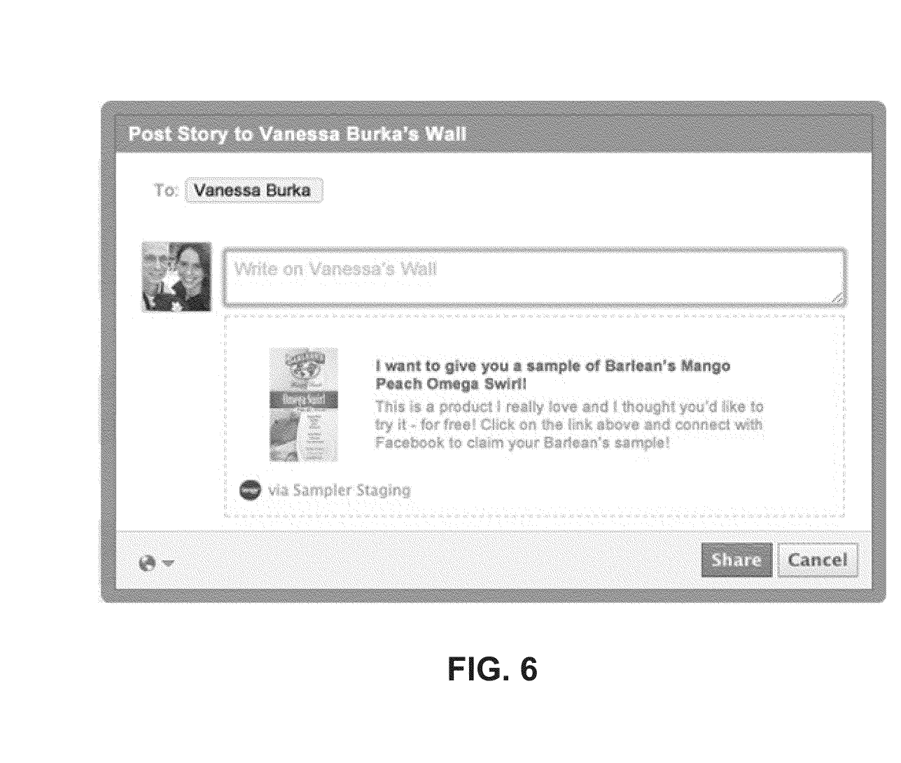

Senders may be encouraged to personalize a personal message to their friends recommending them to try the product. This personal recommendation and a pre-selected marketing message (set by the administrators) may be posted to one or more social media channels, such as the Facebook™ timelines of various users. FIG. 6 provides a sample screenshot of an interface where a “story” is designated to be posted to a user's Facebook™ wall, according to some embodiments.

The link posted on the user's wall may be associated to the recipient's own Facebook™ account and only he/she can access the sample.

The recipient of the promotional offer may choose to claim their promotional offer in various ways, such as mail, through online coupons, through printable PDFs, etc. The delivery method may be predetermined by the administrators during the management/administration of one or more campaigns and/or one or more promotional offers.

By mail: Recipients enter their shipping information. In some embodiments administrators may have provided for the ability for recipients to customize the promotional offering by allowing users to pick from one or more options. For example, users may be able to select a variation of the sample here whether it be a color, size or flavor.

Via Online Coupon: The system may generate a unique online coupon that users can use on the brand's ecommerce site.

Via Printable PDF presentable in store: The system may generate a unique printable PDF that users can redeem in various channels, such as a physical retail location. In some embodiments, the system may provide an image and/or a quick response (QR) code that may be presented in various channels.

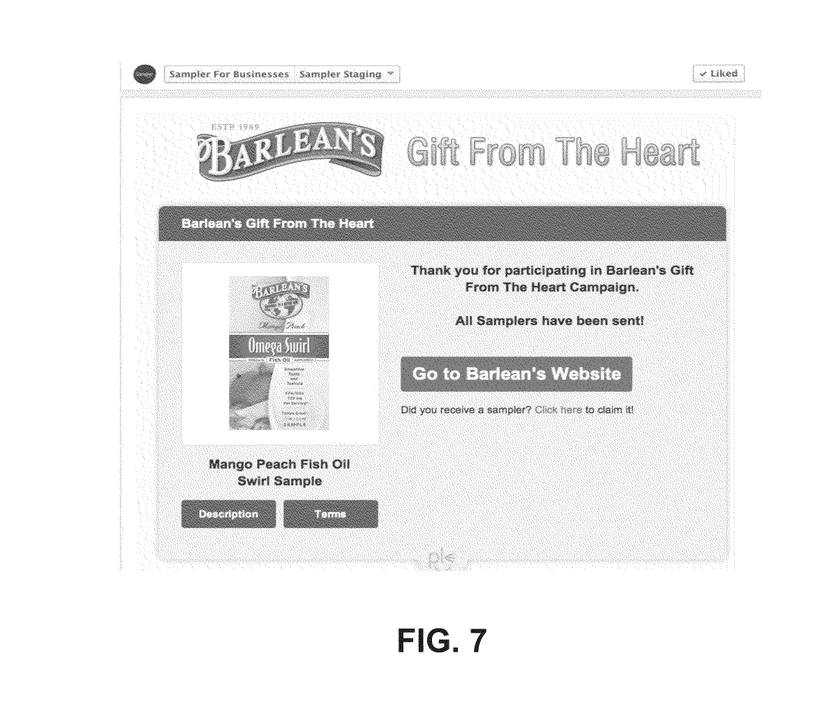

The system may be configured to help brands manage their sample inventory. For example, only a pre-set number of samples selected will be distributed. After that number is reached a “Promotion Ended” message will automatically appear. FIG. 7 provides a sample screenshot of an interface where a user is displayed a message where all the promotional offers have already been sent, according to some embodiments.

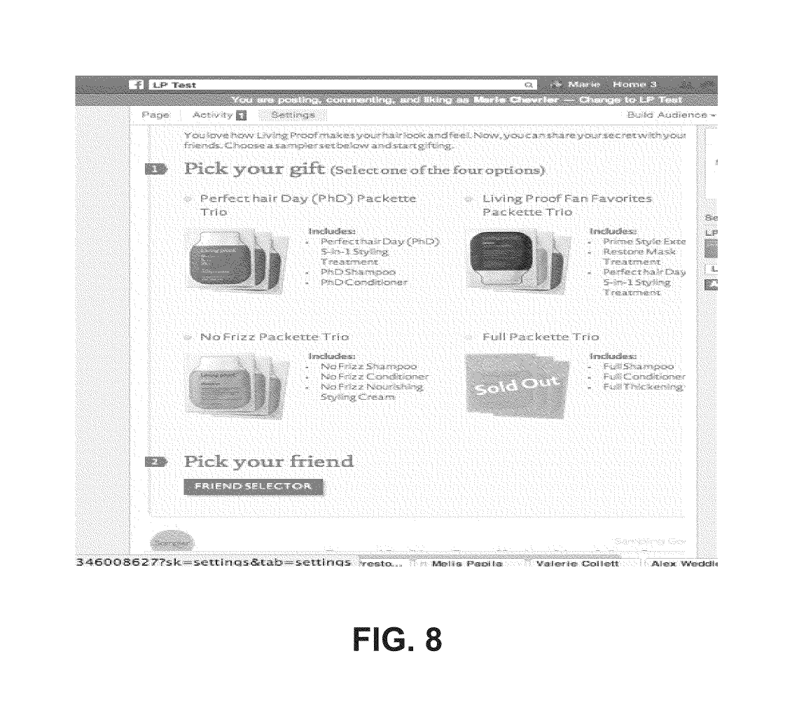

The system may also be configured to manage the inventory of one or more different promotional offers. For example, where promotional offers are samples, if an administrator, wanted to make 300 samples of Sample A available and only 10 of Sample B, the system may be configured to track and/or manage the inventory of each sample type independently. FIG. 8 provides a sample screenshot of an interface where a user is displayed a screen indicating that one sample (the Full Packette Trio) has been had its inventory exhausted, according to some embodiments.

The system may be configured to track the activities of users and/or other information and may be configured to give reports on the following metrics, for example:

How many samples were sent to friends

How many samples were redeemed

What was the Age, Sex & Location of senders on average

What % of senders were a certain Age, Sex & Location

What was the Age, Sex & Location of recipients on average

What % of recipients were a certain Age, Sex & Location

How many likes did the promotion create

How many unique visitors did the promotion receive

How many views did the promotion receive

How many wall posts did the promotion receive

The system may be configured to track users who already participated in a brand's promotion to exclude them from receiving another offer in a future promotion.

The system may be configured to provide decision support to administrators to help understand which of their users had the highest viral coefficient during the promotion/was most influential during the promotion.

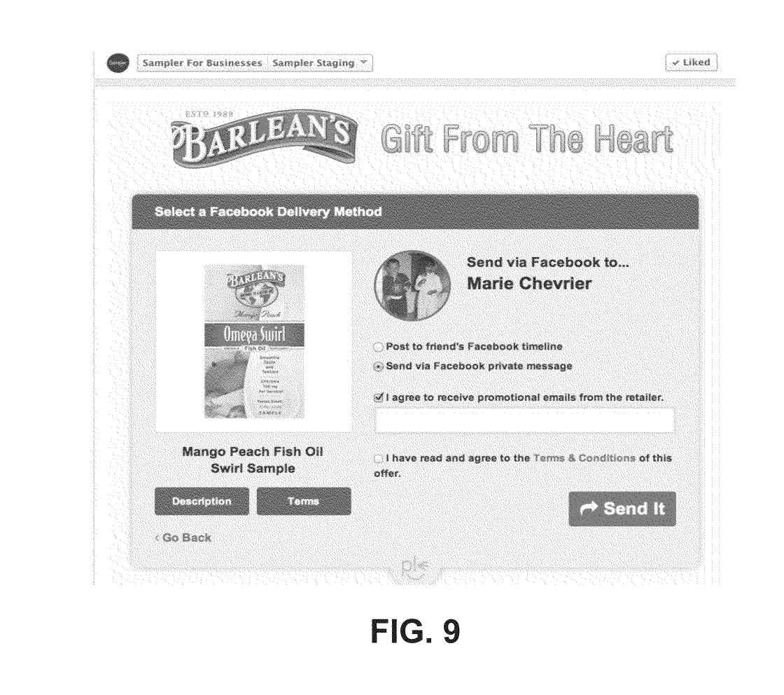

The system may be configured to help administrators collect newsletter registrations, such as email subscriptions, etc. For example, the system may be configured to display to users a “pre-checked” newsletter registration box and pre-fills their email address with the one associated to their Facebook™ account. FIG. 9 provides a sample screenshot of an interface where a user is displayed a screen where the user may select a delivery method, also an option to sign up for promotional emails and send a private message, according to some embodiments.

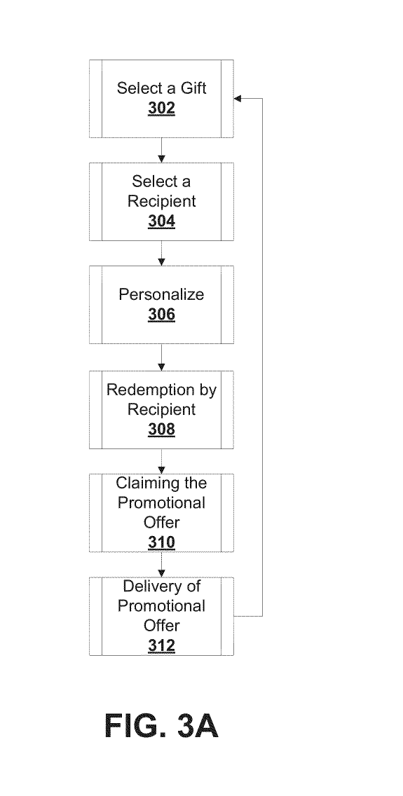

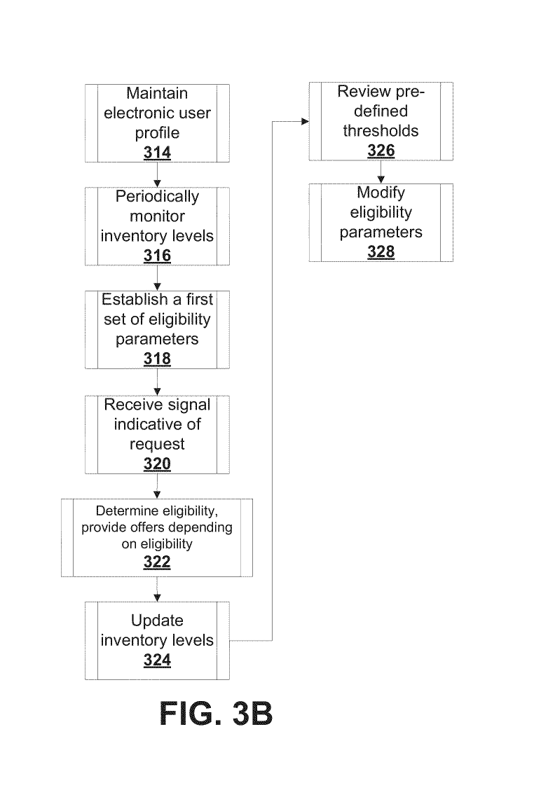

Referring to FIG. 3A, FIG. 3A provides a workflow diagram illustrating steps a user may conduct to send a promotional offer to one or more other users (e.g., their contacts), according to some embodiments. The steps and examples provided are for illustrative, non-limiting purposes.

At step 302, a user may be able to select a promotional offer to send to another user. Each promotional offer selected may have its own targeting settings (e.g., a shampoo sample may have a different target demographic than an aftershave sample). In some embodiments, selecting the product first may be advantageous in later identifying and/or suggesting one or more contacts that may fit the target market in the next step, through the application of one or more rules by the rules engine.

At step 304, the user may select a recipient through a filtered subset of their contacts.

The user interface may be configured to interoperate with the platform integration subsystem to load a selectable list of contacts that meet the targeting options for the specific product selected, as defined by one or more rules. For example, targeting can be conducted on age, sex, location, etc.

At step 306, the user may be able to personalize and send a message to the recipient.

In some embodiments, senders may be encouraged to personalize a personal message to their contacts recommending them to try the product. This personal recommendation and/or a pre-selected marketing message (as may be set by the brand) may be posted to the user's and/or recipient's online social media accounts. Samples or Coupons can be sent via, for example: private messages, wall/timeline postings, email and/or SMS.

At step 308, the recipient redeems the promotional offer through a redemption link.

Each message may include a redemption link. The redemption link posted on the user's wall may be associated to the recipient's own social media account and only he/she can access the promotional offer.

At step 310, the system may be configured to require that a recipient must return to the brand's re-marketing channel to claim their sample. In some embodiments, the system may be configured to require various actions on the part of recipients prior to receiving the promotional offer, such as, a requirement to like a Facebook™ fan page, subscribe to a newsletter, enter a contest, etc. In some embodiments, a user may have to confirm their email address and/or connect/login using their social media account. Such a requirement may be advantageous from a marketing/brand perspective to help continue a conversation with consumers beyond the promotional offer.

At step 312, the system may be configured to receive shipping information and to arrange for delivery of the promotional offer, through various means described above. At this step, there may be additional rules monitored and/or applied, such as allowing users to select variations on promotional offers, restricting shipping only to particular jurisdictions (e.g., for targeting reasons), etc. In some embodiments, the system may be further configured to allow the recipient to send a promotional offer to one or more of their contacts through step 302, where there are still promotional offers still available for gifting.

Referring to FIG. 3B, FIG. 3B provides a workflow diagram illustrating steps that the system may take to tailor the provisioning of promotional offers, according to some embodiments. The steps and examples provided are for illustrative, non-limiting purposes.

At step 314, the data storage 250 may be storing user specific information in the form of electronic user profiles, each electronic user profile corresponding to each of the one or more users.

At step 316, the inventory management system 220 may be periodically monitoring inventory levels of one or more promotional offers.

At step 318, the rules engine subsystem 210 may be configured for establishing a first set of eligibility parameters (e.g., through the provisioning of specific logical rules), the eligibility parameters being based at least on the user specific information stored in the electronic user profiles and defining a subset of the one or more users).

At step 320, upon receipt of a signal indicative of a user's interest in receiving one of more promotional offers from a user interface subsystem 206, the rules engine subsystem 210, in coordination with the user profile stored on data storage 250, the platform integration subsystem and/or the inventory management subsystem 220, automatically determines eligibility of the user to receive the one or more promotional offers based in part on characteristics stored within the electronic user profile corresponding to the user and the inventory levels of the one or more promotional offers.

At step 322, where the user is determined to be eligible to receive the one or more promotional offers, the rules engine subsystem 210 causes the distributing of a first set of promotional offers to the user, and where the user is determined not to be eligible to receive the one or more promotional offers, distributing a second set of promotional offers to the user, wherein the first set of promotional offers is different than the second set of promotional offers (e.g., a potentially less desirable or scarce promotional offer, such as a coupon code instead of a physical sample). In some embodiments, where a user is not eligible, no promotional offer may be provided (instead of providing a second set of promotional offers).

At step 324, the inventory management subsystem 220 updates the inventory levels based on the set of promotional offers distributed to the user.

At step 326, the inventory management subsystem 220 determines whether the inventory levels of the one or more promotional offers will be reduced below a predefined threshold. There may be more than one predefined thresholds, and this is only an example embodiment. In some embodiments, the threshold may be based at least in part to other factors, such as the amount of page impressions on a social media platform, a number of promotional offers provided but not redeemed, availability of shipping, a redemption speed, etc. In some embodiments, triggering conditions may be used in place of thresholds.

At step 328, upon a determination that the inventory levels will be reduced below a predefined threshold, the rules engine subsystem 210 establishes a second set of eligibility parameters defining a subset of the one or more users that is smaller than the subset defined by the first set of eligibility parameters.

There may be other variations. For example, in some embodiments, information recorded in the data storage 250 and may be used by the analytics subsystem 214 to determine a redemption rate (e.g., by interfacing and receiving inventory information from the inventory management subsystem 220), and compare the redemption rate against a desired redemption rate. If the redemption rate is faster than desired (e.g., promotional offers will run out prior to desired end of the promotional period), the system may attempt to slow down the redemption rate by implementing stricter eligibility criteria. Conversely, if the rate is slower than desired (e.g., promotional offers will run out prior to desired end of the promotional period), the system may attempt to slow down the redemption rate by implementing looser eligibility criteria.

Determining which Users have Participated in a Promotion

The system may be configured to provide functionality for administrators to look up users who participated in a promotion. This feature may be advantageous in allowing customer service teams to easily manage customer service requests. In some embodiments, the user lookup feature may allow administrators to look users up by name of Facebook account URL and may show the status of each user's order/promotional offer.

For Brands Looking to Conduct In-Store Sampling. The system may be configured to distribute unique coupon codes or QR codes that can be redeemed at the store with a mobile phone. Working with various external systems (which may include organizational systems and/or their clearinghouses), the system may be configured to associate information regarding exactly who claimed the sample in-store. This includes information regarding the user's age, sex & location as well as whether they were new fans of the brand or not.

Interface Customization and Other Features

The system may be configured to help administrators customize interface elements such as application layout; application colors; application copy/texts & fonts; product descriptions; terms & conditions for promotion; etc.

The system may also be configured to suggest a “Best Practice” user experience based on a promotional offer's category and/or objectives.

The system may also be configured to send reminder notifications (e.g., SMS, emails), where a targeted user have not yet redeemed their promotional offer.

The system may also be configured to provide a follow-up survey that may be communicated after product samples have been shipped and/or redeemed in store. In some embodiments, only users who received the sample will be able to access the follow-up survey.

Some platforms may require consent prior to accessing user information. The system may be configured to automatically request consent for these permissions. In some embodiments, the system may be further configured to only request consent for permissions where the permission is necessary for the type of targeting that the particular promotion is configured for. For example, if a campaign is not targeting users based on age, the application will not request user birthdays.

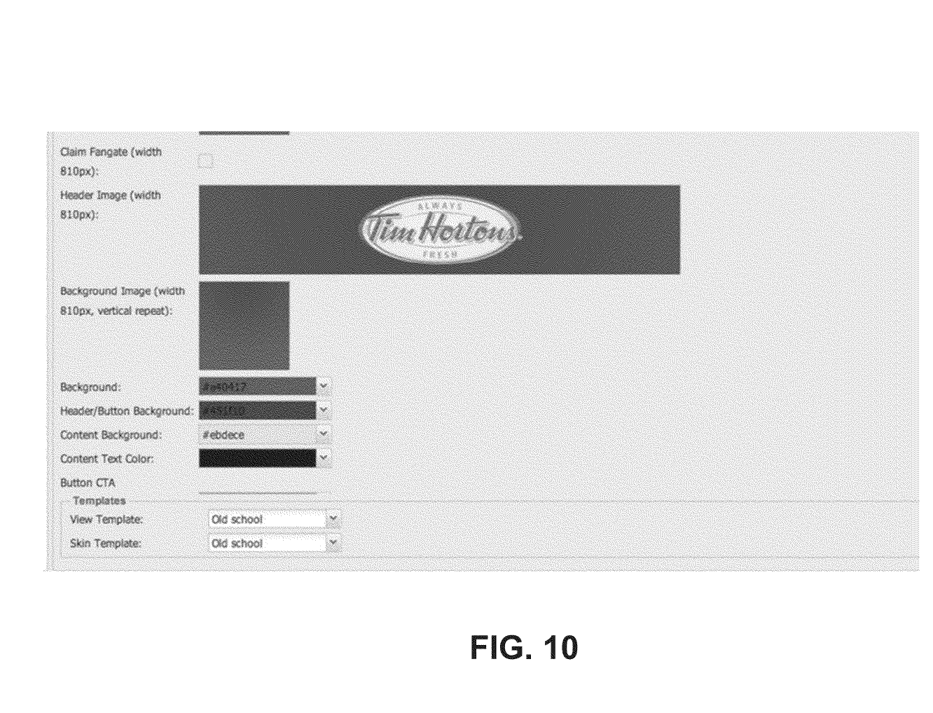

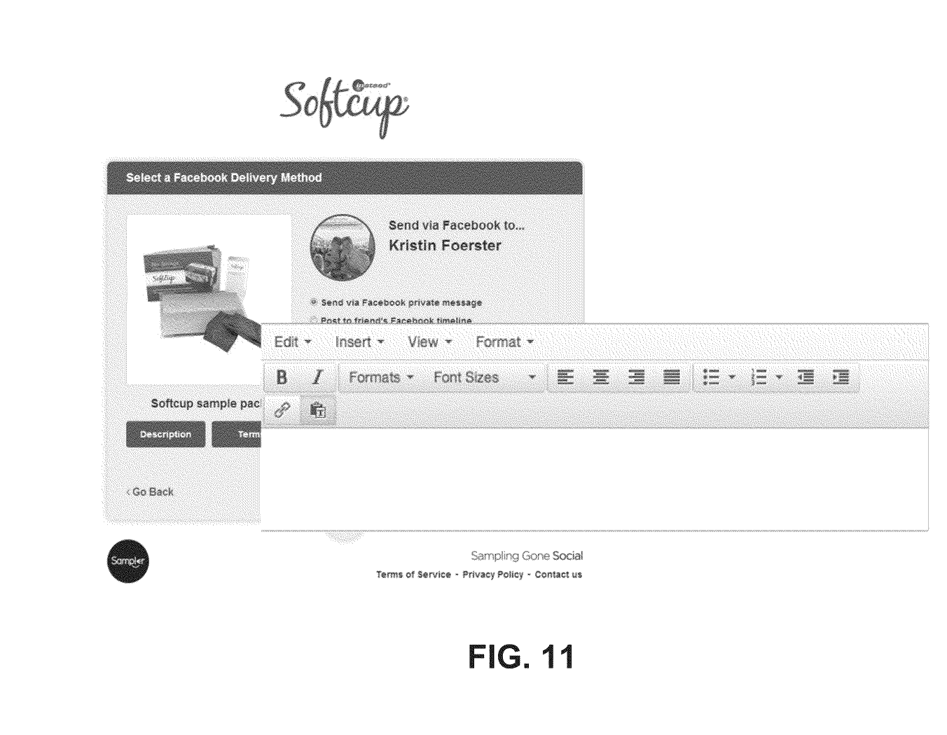

FIGS. 10 and 11 provide sample screenshots of the administrative interface that may be configured to enable an administrator to determine the look and feel the user interface, according to some embodiments.

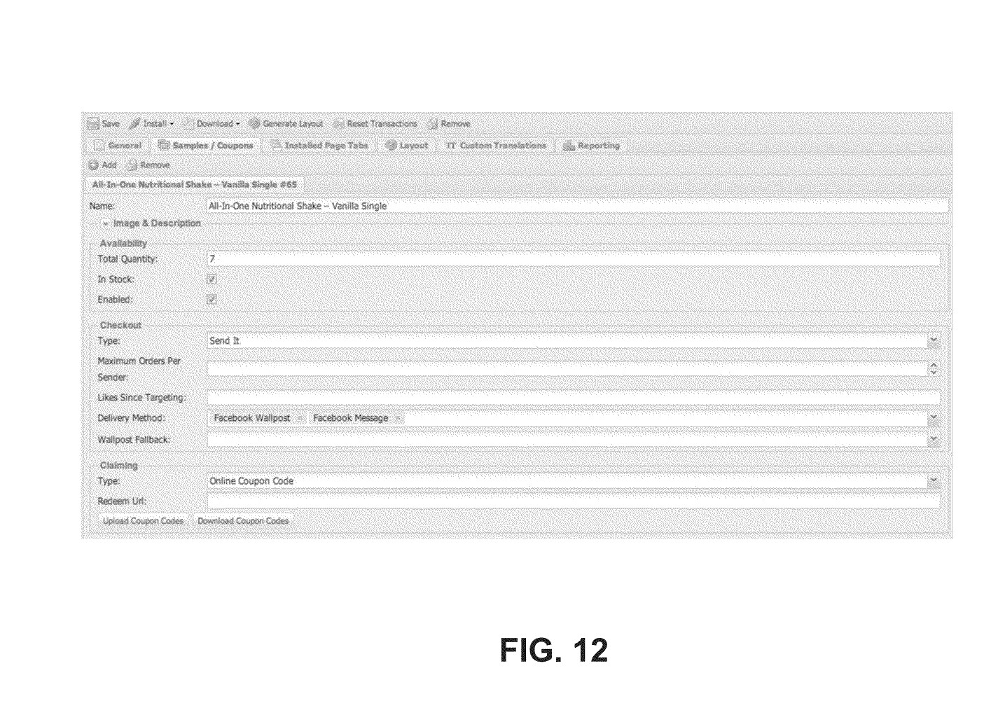

FIG. 12 provides a sample screenshot of the administrative interface that may be configured to define various characteristics and/or rules related to one or more promotional offers, according to some embodiments.

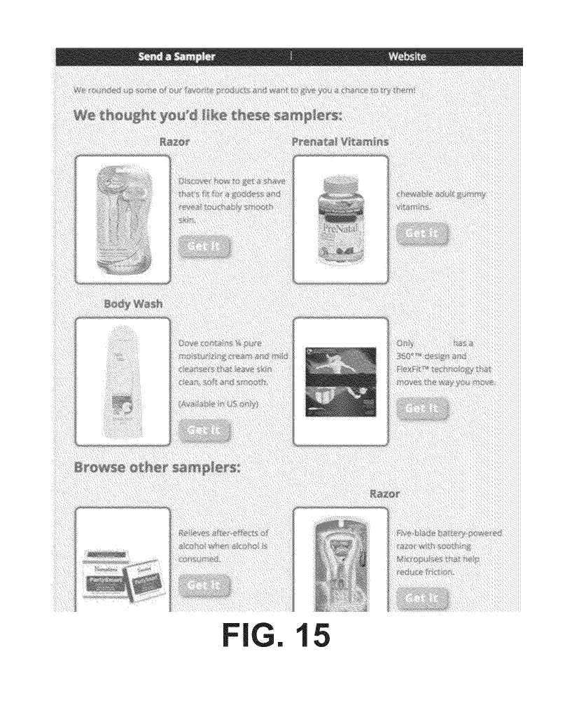

FIG. 15 provides sample screenshots of a user interface illustrating product recommendations of other promotional offers, according to some embodiments.

Redemption Period

The system may be configured to give users 7 days after the sample was sent to redeem their sample using the “Mail Redemption” method. Such a configuration may help administrators manage an influx of incoming requests. After the week, the offer may be set to expire. This period may customizable, for example.

Online Sampling Events

The system may be configured to interoperably host online promotional events like

“The Ultimate Online Baby Shower”. For example, during these events, users may be invited to visit a different brand Facebook fan page every day to send a friend a promotional offer. Users may follow the online sampling event, for example, from a calendar posted on various pages, such as sponsor/brand pages. These cross-promotion activities may help non-competitive brands within a same category cross-promote each other on one or more social platforms.

For example, a RSVP page may be provided by the system which may, for example, lead to a page where a calendar of events is provisioned for the user that displays events related to different brands together that are determined to be relevant to a user's interests and/or based on one or more advertising campaigns (e.g., a wellness week). In this example, the system provides a cross-promotional activity for various brands (e.g., smaller brands) and may aid targeting as relevant brands and/or offers may be shown to the user that may be indirectly associated with the promotion that the user may have been accessing the system to gain access to.

Fan-Gated sampling

In some embodiments, in order to obtain access to a promotional offer, such as a sample, the system may be configured to require users to “Like” the Facebook fan page of a brand.

Sending Promotional Offers After Redeeming Promotional Offers

In some embodiments, the system may be configured to enable users who just bought a product type or brand to send a promotional offer to friends at the end of their check-out experience. The promotional offer can be sent through a variety of means such as Facebook™ wall post, Facebook™ message, SMS/text message, MMS, and/or email.

RSVP Prior to Events

For various business reasons such as the desire to create another layer of exclusivity, administrators could set one or more rules that require users to RSVP before the event started in order to be eligible to send or receive a sample before the event starts.

This functionality may allow administrators the ability to define rules to “qualify” users before the event starts.

Only users who match the correct profile could be accepted to sample. This may also provide a potentially convenient method to collect emails before the event so that an administrator may send out various communications related to the event to the fans a couple times before it actually starts.

Incentivization/Motivation Rules

In some embodiments, the rules engine may be configured to incentivize users to share an offer with friends. In this example, a user must have 3 friends claim the offer in order to claim a special offer for that specific user. Other criteria may be contemplated.

In some further embodiments, the user interface subsystem may be configured to enable users to keep track of whether or not their friends have claimed their offer.

For Measuring Offer Performance

The analytics subsystem may be configured to provide various metrics for measure performance, for example: total offers sent; total offers redeemed (for peer recommendation); total unique visitors to promotion; total page views; total orders per date, etc.

In some embodiments, the analytics subsystem may be configured to interoperate with various external systems to identify when in-store promotional offers have been redeemed. The information may be potentially useful in determining trends beyond the system 200 and relating to the overall ability to convert demographics at the point of sale.

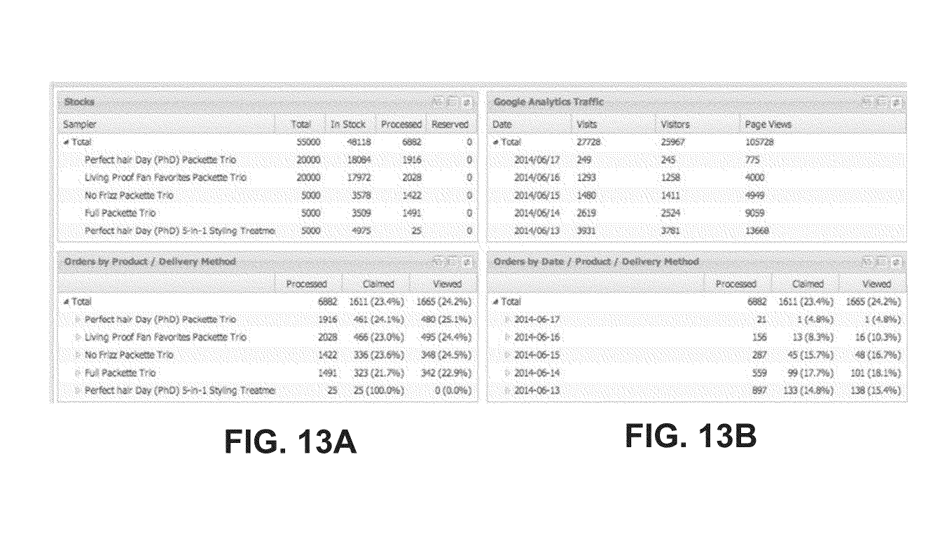

FIGS. 13A and 13B provide sample screenshots of the interface that may be configured to provide an administrator with a view of tracked statistics, according to some embodiments.

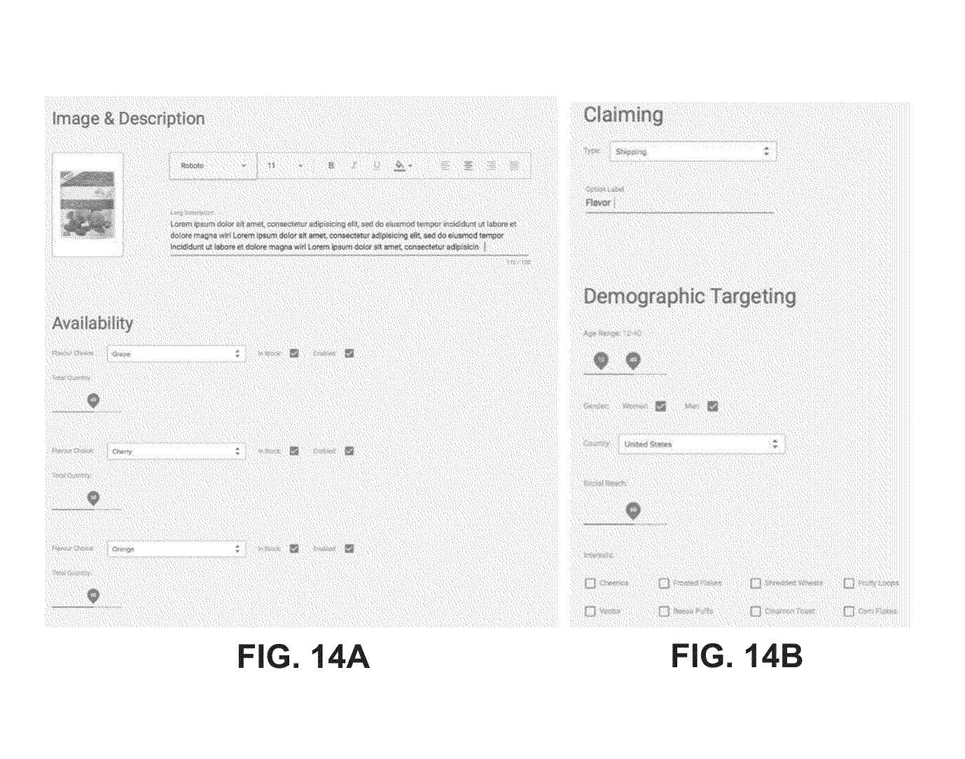

FIGS. 14A and 14B provides sample screenshots of the administrative interface that may be configured to provide an administrator the ability to set eligibility criteria and options related to a promotional offer, according to some embodiments.

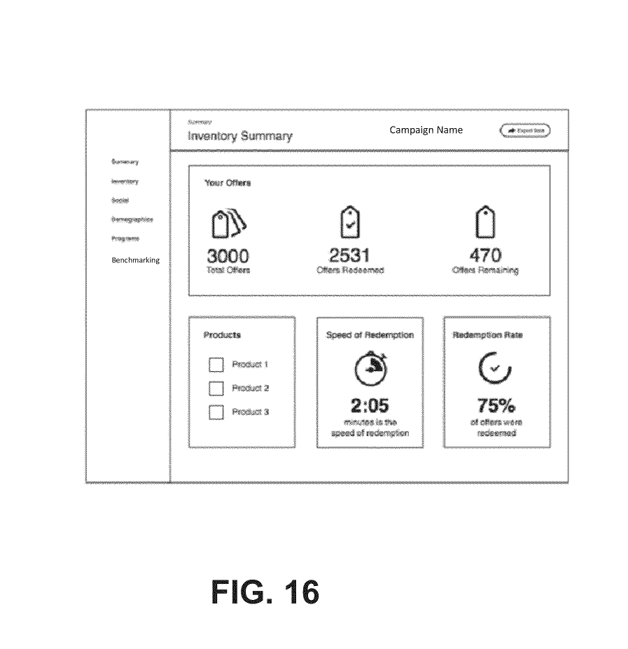

FIG. 16 provides a sample screenshot of the administrative interface that may be configured to provide an administrator with a view of inventory and redemption statistics, according to some embodiments.

As provided in FIG. 16, the administrative interface may provide various elements of information that are determined and/or obtained by the analytics subsystem 214, through, for example, analyzing various aspects of information gathered from redemption of promotional offers, inventory information stored on inventory management subsystem 220, user profiles stored on data storage 250, information retrieved from various social media platforms from platform integration subsystem 212, etc. This information may include a speed of redemption, a redemption rate, etc., and this information may also be retrieved from various external systems, such as point of sale systems, shipping systems, etc., which are able to track how, where, when, etc., promotional offers are redeemed. This is an example of the inventory summary, but there may be other types of summaries provided, demographic information, social media reach information, and competitive information (e.g., programs being run and compared against other programs, including how others within your category performed compared to a specific program).

### General

As will be further understood by those skilled in the relevant arts, significant advantage may be realized through the full or partial automation of any of the processes described above, or portions thereof. Such automation may be provided in any suitable manner, including for example the use of automatic data processors executing suitably-configured, coded, machine-readable instructions using a wide variety of devices, some of which are known and others of which will doubtless be developed hereafter. Processor(s) suitable for use in such implementations can comprise any one or more data processor(s), computer(s), and/or other system(s) or device(s), and necessary or desirable input/output, communications, control, operating system, and other devices or components, including software, that are suitable for accomplishing the purposes described herein. For example, a suitably-programmed general-purpose data processor provided on one or more circuit boards will suffice.

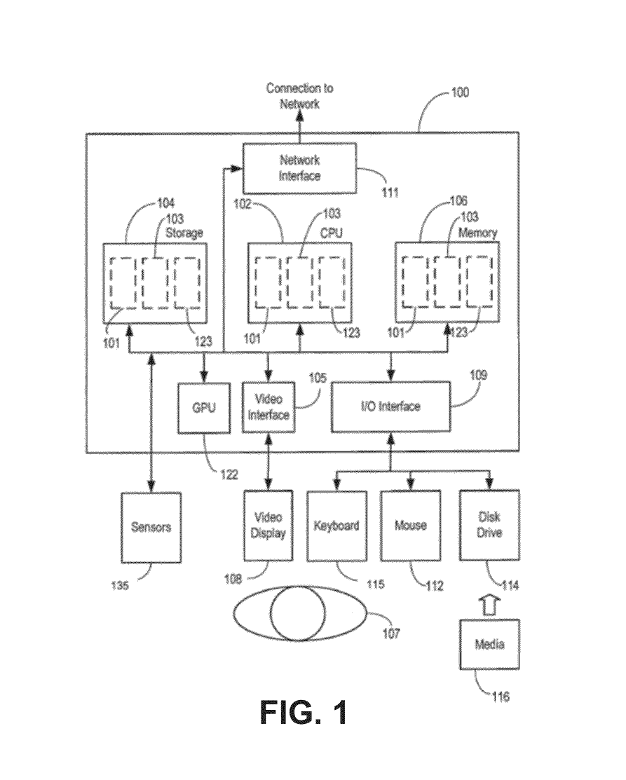

The present system and method may be practiced in various embodiments. A suitably configured computer device, and associated communications networks, devices, software and firmware may provide a platform for enabling one or more embodiments as described above. By way of example, FIG. 1 shows a computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 115, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 135 may be used to receive input from various sources.

The present system and method may be practiced on computer devices including a desktop computer, laptop computer, tablet computer or wireless handheld having the ability to connect with the Internet and/or various social networking platforms and/or promotional offer inventory systems. In some embodiments, the systems and methods may be performed on distributed networking devices, such as devices arranged in a “cloud computing” implementation.

The present system and method may also be implemented as a computer-readable/useable medium that includes computer program code to enable one or more computer devices to implement each of the various process steps in a method in accordance with the present disclosure. In case of more than computer devices performing the entire operation, the computer devices are networked to distribute the various steps of the operation.

It is understood that the terms computer-readable medium or computer useable medium comprises one or more of any type of physical embodiment of the program code. In particular, the computer-readable/useable medium can comprise program code embodied on one or more portable storage articles of manufacture (e.g., an optical disc, a magnetic disk, a tape, etc.), on one or more data storage portioned of a computing device, such as memory associated with a computer and/or a storage system.

The mobile application of the present disclosure may be implemented as a web service, where the mobile device includes a link for accessing the web service, rather than a native application.

The functionality described may be implemented to various mobile platforms, including the iOS™ platform, ANDROID™, WINDOWS™ or BLACKBERRY™.

It will be appreciated by those skilled in the art that other variations of the embodiments described herein may also be practiced without departing from the scope of the disclosure. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the disclosure, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the disclosure.

What is claimed is:

1. A computer implemented method for managing distribution of one or more promotional offers to one or more users, performed by a processor of a distribution management system, the method comprising:
storing user specific information in the form of electronic user profiles, each electronic user profile corresponding to each of the one or more users;
periodically monitoring inventory levels of one or more promotional offers;
establishing a first set of eligibility parameters, the eligibility parameters being based at least on the user specific information stored in the electronic user profiles and defining a subset of the one or more users;
upon receipt of a signal indicative of a user's interest in receiving one of more promotional offers, automatically determining eligibility of the user to receive the one or more promotional offers based in part on characteristics stored within the electronic user profile corresponding to the user and the inventory levels of the one or more promotional offers;
where the user is determined to be eligible to receive the one or more promotional offers, distributing a first set of promotional offers to the user;
where the user is determined not to be eligible to receive the one or more promotional offers, distributing a second set of promotional offers to the user;
wherein the first set of promotional offers is different than the second set of promotional offers;
updating the inventory levels based on the set of promotional offers distributed to the user;
determining whether the inventory levels of the one or more promotional offers will be reduced below a predefined threshold;
and upon a determination that the inventory levels will be reduced below a predefined threshold, establishing a second set of eligibility parameters defining a subset of the one or more users that is smaller than the subset defined by the first set of eligibility parameters.

2. The method of claim 1, wherein the user specific information stored in the form of the electronic user profiles includes an electronic listing of one or more other users connected with the user associated with each electronic user profile, and user characteristic information for each of the one or more other users.

3. The method of claim 2, wherein the step of distributing the first set of promotional offers to the user further comprises:
retrieving the electronic listing of the one or more other users connected with the user;
using the first set of eligibility parameters, determining an eligible subset of the one or more other users;
presenting, through a user interface coupled to the distribution management system, the eligible subset of the one or more other users to the user;
receiving, through the user interface coupled to the distribution management system, a selection of one or more other users by the user; and
transmitting an electronic invitation to receive the first set of promotional offers to the selected one or more other users.

4. The method of claim 1, further comprising providing an invitation to the one or more users in the form of an electronic resource locator, including at least one of a uniform resource locator (URL) and a quick reaction code (QR code).

5. The method of claim 4, wherein the invitation is provided through at least one of an in-store advertisement, an insert provided in a product, on product packaging, a print publication, and an electronic advertisement.

6. The method of claim 1, wherein the first set of eligibility parameters or the second set of eligibility parameters include at least a parameter related to whether a user has an association with an electronic profile of an organization affiliated with the one or more promotional offers.

7. The method of claim 1, wherein the inventory levels are indicative of current and expected inventory availability.

8. The method of claim 1, wherein the one or more users provides the signal indicative of the user's interest in receiving the one or more promotional offers through at least one of a signal generated through the use of a social media platform, a mobile application, and a computer program.

9. The method of claim 1, wherein the one or more promotional offers includes at least one online coupons, physical coupons, physical products, virtual products, services, options to purchase, options to sell, exclusive access, reservations, rebates, contests, premium offers, and access to special sales events.

10. The method of claim 1, the method further comprising:
upon receipt of the signal indicative of a user's interest in receiving one of more promotional offers, updating the electronic user profile associated with the user to include user specific information relating to the source of the signal indicative of the user's interest.

11. The method of claim 1, the method further comprising:
upon receipt of the signal indicative of a user's interest in receiving one of more promotional offers, inferring demographic characteristics of the user relating to the source of the signal indicative of the user's interest and updating the electronic user profile associated with the user to include the inferred demographic characteristics of the user.

12. The method of claim 1, further comprising:
determining one or more economic scores for each of the one or more users based at least in part on user specific information stored in the users' electronic user profiles;
wherein at least one of the first and second sets of eligibility criteria include a criterion related to the determined economic scores.

13. The method of claim 1, wherein the one or more potential economic scores includes at least one of a future revenue score, and a future profit score.

14. A system for managing distribution of one or more promotional offers to one or more users, the system having a processor and non-transitory computer readable media, the non-transitory computer readable media containing electronic instructions which cause the processor to:
store user specific information in the form of electronic user profiles, each user profile corresponding to each of the one or more users;
periodically monitor inventory levels of one or more promotional offers;
establish a first set of eligibility parameters, the eligibility parameters being based at least on the user specific information stored in the electronic user profiles and defining a subset of the one or more users;
upon receipt of a signal indicative of a user's interest in receiving one of more promotional offers, automatically determine eligibility of the user to receive the one or more promotional offers based in part on characteristics stored within the electronic user profile corresponding to the user and the inventory levels of the one or more promotional offers;
where the user is determined to be eligible to receive the one or more promotional offers, distribute a first set of promotional offers to the user;
where the user is determined not to be eligible to receive the one or more promotional offers, distribute a second set of promotional offers to the user;
wherein the first set of promotional offers is different than the second set of promotional offers;
update the inventory levels based on the set of promotional offers distributed to the user;
determine whether the inventory levels of the one or more promotional offers will be reduced below a predefined threshold; and
upon a determination that the inventory levels will be reduced below a predefined threshold, establish a second set of eligibility parameters defining a subset of the one or more users that is smaller than the subset defined by the first set of eligibility parameters.

15. The system of claim 14, the system comprising:
one or more utilities configured to track the distribution of one or more promotional offers to one or more eligible users;
one or more utilities configured for defining one or more sets of rules;
one or more utilities configured for applying one or more sets of rules;
wherein the one or more sets of rules define various properties of the one or more promotional offers; and
wherein the one or more eligible users are a subset of the one or more users.

16. The system of claim 14, wherein the user specific information stored in the form of the electronic user profiles includes an electronic listing of one or more other users connected with the user associated with each electronic user profile, and user characteristic information for each of the one or more other users.

17. The system of claim 14, wherein the non-transitory computer readable media contains electronic instructions which cause the processor to:
retrieve the electronic listing of the one or more other users connected with the user;
using the first set of eligibility parameters, determining an eligible subset of the one or more other users;
present, through a user interface, the eligible subset of the one or more other users to the user;
receive, through the user interface, a selection of one or more other users by the user; and
transmit an electronic invitation to receive the first set of promotional offers to the selected one or more other users.

18. The system of claim 14, wherein the non-transitory computer readable media contains electronic instructions which cause the processor to provide an invitation to the one or more users in the form of an electronic resource locator, including at least one of a uniform resource locator (URL) and a quick reaction code (QR code).

19. The system of claim 14, wherein the invitation is provided through at least one of an in-store advertisement, an insert provided in a product, on product packaging, a print publication, and an electronic advertisement.

20. A non-transitory computer readable medium, storing instructions thereon which when executed, cause a processor to perform steps of a method comprising:
storing user specific information in the form of electronic user profiles, each electronic user profile corresponding to each of the one or more users;
periodically monitoring inventory levels of one or more promotional offers;
establishing a set of eligibility parameters, the eligibility parameters being based at least on the user specific information stored in the electronic user profiles and defining a subset of the one or more users;
upon receipt of a signal indicative of a user's interest in receiving one of more promotional offers, automatically determining eligibility of the user to receive the one or more promotional offers based in part on characteristics stored within the electronic user profile corresponding to the user and the inventory levels of the one or more promotional offers;
where the user is determined not to be eligible to receive the one or more promotional offers, notifying the user that the user is not eligible to receive the one or more promotional offers.
